(19) United States
(12) Patent Application Publication
(10) Pub. No.: US 2004/0252768 A1
(43) Pub. Date: Dec. 16, 2004

(54) Computing apparatus and encoding program

(76) Inventors: Yoshinori Suzuki, Saitama (JP); Junichi Kimura, Koganei (JP); Muneaki Yamaguchi, Inagi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/639,656

(22) Filed: Aug. 13, 2003

(30) Foreign Application Priority Data
Jun. 10, 2003 (JP) 2003-164908

(51) Int. Cl. H04N 7/12

(52) U.S. Cl. 375/240.24; 375/240.01; 375/240.12

(57) ABSTRACT

Disclosed herewith a motion picture coding apparatus connected to a plurality of resources for computing and used together with the plurality of resources to code input images. The apparatus is provided with a region dividing unit for dividing input image into a plurality of regions, a control unit for allocating a prediction mode selection processing for each of the divided regions to a plurality of resources for computing, a region data output unit for outputting divided regions to a plurality of resources for computing, a prediction type receiving unit for receiving prediction mode information selected in the resource for computing, and an image data receiving unit for receiving coded data coded an input image in the selected prediction type. The apparatus can thus code input images in cooperation with the plurality of connected resources for computing.

### BACKGROUND OF THE INVENTION

1. Field of the Invention

The present invention relates to a coding technique for motion pictures (frames), which codes data in a distributed manner with use of a plurality of resources for computing.

2. Description of Related Art

There is a well-known method that codes motion pictures (mainly as the MPEG-2 coding) in real time with use of a plurality of resources for computing (ex., computers, processors, CPUs, etc.).

For example, there is a method that divides an input image into a plurality of image regions, then codes those image regions in parallel with use of a plurality of computers. This method uses one of the plurality of computers as a main computer for controlling the whole system and other computers for coding images. The main computer controls the input/output synchronization of data (input of images and output of coded data) to/from the computers for coding and the coding performance (coding rate) (refer to the patent document 1).

There is also another method that codes data of a plurality of blocks in parallel with use of a plurality of processors. This method manages the progress of the processing in each processor so as to minimize the waiting time of each processor for an output processing in consideration of the output order of coded block data, thereby making good use of the features of both motion prediction that enables parallel processings and residual coding that requires one-after-another processings (refer to the patent document 2).

The AVC (Advanced Video Coding), which is a coding method provided with many prediction types, is well known as such a coding method for motion pictures (frames). In this AVC, a frame is composed of a luminance signal (Y signal: 61) and two color difference (chrominance) signals (Cr signal: 62 and Cb signal: 63) as shown in FIG. 21. The image size of a color difference (chrominance) signal becomes ½ of that of the luminance signal in both vertical and horizontal directions. Each frame is divided into blocks and coded block by block. This small block is referred to as a macroblock and composed of a Y signal block 45 consisting of 16×16 pixels and a Cr signal block 46 and a Cb signal block 47 consisting of 8×8 pixels respectively. The two 8×8 blocks of chrominance data correspond spatially to a 16×16 section of luminance component of a frame (refer to the non-patent document 1).

Next, a description will be made for a prior motion picture coding apparatus that employs the AVC with reference to the block diagram shown in FIG. 23.

Each input image is divided into input macroblocks in a block dividing unit 101. Divided input macroblocks are then inputted to a subtraction processing unit 103. The subtraction processing unit 103 executes a subtraction processing for each pixel between an input macroblock and a predictive macroblock generated in an intra-prediction unit or motion compensation unit to output a residual macroblock. The residual macroblock is inputted to a discrete cosine transformation (DCT) unit 104. The DCT unit 104 divides residual macroblock into some small blocks and executes a frequency transform for each of them to generate a DCT block. Each DCT block has a size of 8×8 pixels in the prior MPEG method and a size of 4×4 pixels in the AVC.

The DCT unit 104 divides a residual macroblock into 24 4×4-pixel blocks (40-1 to 40-15, 41-0 to 41-3, and 42-0 to 42-3) as shown in FIG. 24. Each 4×4-pixel block is transformed to a DCT block. Then, for DC blocks (40-16, 41-4, 41-4), each of which extracts only the DC component of a 4×4 DCT block, a DCT is executed (there are some cases that the DC block of luminance signal component is not executed DCT depending on some prediction types). The transformation coefficients in each DCT block are inputted to a quantizing unit 105.

The quantizing unit 105 quantizes the transformation coefficients in each DCT block according to the quantizer parameters inputted from the control unit 102. In the AVC, 52 types of quantizer parameters are prepared. The smaller the value of each quantizer parameter is, the higher the quantization accuracy becomes.

The quantized DCT coefficients are inputted to the variable length coding (VLC) unit 106 to be coded there. At the same time, the quantized DCT coefficients are inputted to the inverse quantizing unit 107. In the inverse quantizing unit 107, the quantized DCT coefficients are de-quantized to reconstructed DCT coefficients according to the quantizer parameters inputted from the control unit. The reconstructed DCT blocks are then transformed inversely to residual blocks in the inverse DCT unit 108 and the reconstructed residual macroblock is inputted to the addition processing unit 109 together with a predictive macroblock.

The addition processing unit 109 adds up pixels of the reconstructed residual macroblock and the predictive macroblock to generate a reconstructed macroblock. This reconstructed macroblock is combined with others in the frame memory 110 so as to be used for an inter-prediction processing.

A series of the processings executed in the inverse quantizing unit 107, the inverse DCT unit 108, and the addition processing unit 109 are referred to as “local decoding”. This local decoding should have a function to generate macroblocks to be reconstructed just like the decoding side.

In addition to the variable length coding, arithmetic coding is also prepared for coding data in the AVC. While the variable length coding is to be described in this document, the coding method may be replaced with the arithmetic coding to obtain the same effect of the present invention.

Next, a description will be made for a prediction method for generating a predictive macroblock, as well as for prediction types.

The prediction methods are roughly classified into two types; intra-prediction and inter-prediction.

The intra-prediction uses coded pixels in current frame to predict pixels in a macroblock. The AVC has two types of block sizes prepared as prediction units. Those units are referred to as a 4×4 intra-prediction and a 16×16 intra-prediction. The 4×4 intra-prediction has 9 types while the 16×16 intra-prediction has 4 types that are different in directivity from each another. Any of those prediction types can be selected for each macroblock independently (for each 4×4 block in the macroblock to which the 4×4 intra-prediction applies).

FIG. 25 shows coded adjacent pixels used for the 4×4 intra-prediction. Any of types has different computing expressions from each another (type 0 to type 8). If two or more computing expressions are prepared for any type, the computing expression to be used comes to differ between positions of pixels.

In the 16×16 intra-prediction, coded pixels adjacent to the target macroblock are used. However, note that both 16×16 intra-prediction and 4×4 intra-prediction are employed only for the luminance components of each macroblock and other four prediction types are prepared for chrominance components. Any of those four prediction types is selected for each macroblock independently.

The inter-prediction uses pixels in coded frame to predict pixels in each macroblock. The inter-prediction is classified into P type used to predict only one frame and B type used to predict two frames.

Next, a description will be made for the concept of motion estimation and motion compensation that are basics of this inter-prediction with reference to FIG. 26. Motion estimation is a technique for detecting a portion similar to the content of a target macroblock from a coded picture (reference picture (frame)). In FIG. 26, a luminance component block 72 is indicated by a thick line in the current picture 71 and a luminance component block 74 is indicated by a broken line in a reference picture 73. In this case, the same position in a frame is occupied by both blocks 72 and 74. When in motion estimation, at first a search rage 77 that encloses the luminance component block 74 is set. Then, a position at which the evaluation value is minimized is searched by moving pixel by pixel in this range 77 both vertically and horizontally. The detected position is decided as a predicted position of the target block. Such an evaluation value is found with use of a function obtained by adding motion vector coding bits to the sum of absolute error or sum of square error of the prediction error signal in the block.

A motion vector means a moved distance and direction from an initial position of a target block to a detected position. For example, if the detected position for the luminance block 74 is the block 75, the motion vector is as denoted with a reference number 76. In the AVC, the accuracy of a motion vector is ¼ pixel. After searching is done at an integer accuracy, ½ pixel and ¼ pixel can be searched around that. On the other hand, motion compensation means a technique for generating a predictive block from both motion vector and reference picture. For example, if reference numbers 72 and 76 denote a predictive block and a motion vector respectively, reference number 75 comes to denote the predictive block.

FIG. 27 shows various sizes of motion compensation blocks of the P type. There are four basic macroblock types as denoted with reference numbers 51 to 54. Any of the types can be selected for each macroblock independently. If an 8×8 block is selected, one of the four sub-block types denoted with reference numbers 54a to 54d is selected for each 8×8 block. In the AVC, a plurality of reference frames (usually one to five frames) are prepared and any of the plurality of reference frames can be selected for prediction for each of the divided blocks (51-0, 52-0 to 52-1, 53-0 to 53-1, and 54-0 to 54-3) in the basic block type.

The selectable motion compensation block sizes of the B type are similar to that of the B type. And, a prediction type (the number of reference frames and direction) can be selected for each of the divided blocks (51-0, 52-0 to 1, 53-0 to 1, and 54-0 to 3) in the basic macroblock type. Concretely, two types of reference frame lists (lists 1 and 2) are prepared and each list includes a plurality of registered reference frames (usually, one to five reference frames). A prediction type can thus be selected from three types of list 1 (forward prediction), list 2 (backward prediction) or both lists 1 and 2 (bi-directional prediction). A reference frame used for prediction can also be selected for each divided block in the basic macroblock type with respect to each list. In the case of the bi-directional prediction, each pixel in two predictive blocks is interpolated to generate a predictive block. In the case of the B type, a prediction type referred to as the direct prediction is further prepared for both 16×16 block and 8×8 block. In this prediction type, a reference frame, a prediction type, and a motion vector of a block are automatically calculated from coded information, so that there is no need to code those information items.

A prediction type selected as described above is inputted to the intra-prediction unit 115 or motion compensation unit 116, so that a predictive macroblock is generated from this prediction type information and coded adjacent pixels in the current frame or a reference frame.

[Patent Document 1]

Official gazette of JP-A 261797/2000

[Patent Document 2]

Official gazette of JP-A 30047/2000

[Non-Patent Document 1]

“Draft Text of Final Draft International Standard for Advanced Video Coding (ITU-T Rec. H.264|ISO/IEC 14496-10 AVC)”, [online]

March 2003, Internet<URL: http://mpeg.telecomitalialab.com/working_documents/mpeg-04/avc/avc.zip>

Each of the prior coding methods has many prediction types and corresponds to a kind of characteristic image regions so that it can provide high quality reconstructed images. However, to keep such a high image quality and code data efficiently, much time has been taken to select one of those prediction types. And, using a plurality of resources for computing used to encode image in a distributed manner is one of the methods to solve such a problem. While there is a configuration of such a distributed coding system as disclosed in the above prior art, the technique limits the data access between resources for computing. The flexibility of the coding also comes to be limited. For example, according to the method disclosed in the patent document 1, it is difficult to execute a prediction processing over the regions allocated to those resources for computing and control the quality of a whole frame. According to the method disclosed in the patent document 2, it is difficult to control the number of processings between macroblocks and the quality of a whole frame. This is why it is hardly possible to execute a processing appropriately to the characteristic changes of images.

### SUMMARY OF THE INVENTION

Under such circumstances, it is an object of the present invention to solve the above prior problems and provide a motion picture coding apparatus connected to a plurality of resources for computing and used together with those resources to compute to code input images. The coding apparatus comprises a dividing unit for dividing an input image into a plurality of regions; a control unit for allocating a prediction mode selection processing for each of the divided regions to a plurality of resources for computing; a region data output unit for outputting divided regions to a plurality of resources for computing; a prediction mode receiving unit for receiving a prediction type selected by a resource for computing; and an image data receiving unit for receiving coded data coded in the selected prediction type. The apparatus codes input images in cooperation with the plurality of connected resources for computing.

More concretely, the motion picture coding apparatus of the present invention can omit a prediction to be made over the regions allocated to different resources for computing respectively and separate the prediction mode selection processing which can execute in parallel from the system management processing and allocate the mode selection processing to a plurality of resources for computing. The apparatus can also allocate a residual coding processing to a single resource for computing. The residual coding processing is required to keep the total balance of image quality, thereby the ordering of the processings is ruled.

The motion picture coding apparatus of the present invention is configured so as to distribute coded data frame by frame to a plurality of resources for computing used to select a prediction type respectively.

### BRIEF DESCRIPTION OF THE DRAWINGS

FIG. 1 is a block diagram of a motion picture coding apparatus in the first embodiment of the present invention;

FIG. 2A, FIG. 2B, and FIG. 2C show an illustration for describing how an input image is divided according to the present invention;

FIG. 3 is a block diagram of a coding unit in the first embodiment of the present invention;

FIG. 4 is a block diagram of a mode selection unit in the first embodiment of the present invention;

FIG. 5 is a block diagram of a data decoding unit in the first embodiment of the present invention;

FIG. 6 is an illustration for describing how a prediction motion vector is generated according to the present invention;

FIG. 7 is a flowchart of the processings of the system management unit in the first embodiment of the present invention;

FIG. 8 is a flowchart of the processings of the mode selection unit in the first embodiment of the present invention;

FIG. 9 is a flowchart of the processings of the coding unit in the first embodiment of the present invention;

FIG. 10 is an illustration for describing a plurality of resources for computing included in a configuration of the motion picture coding apparatus in the first embodiment of the present invention;

FIG. 11 is another illustration for describing a plurality of resources for computing included in the configuration of the motion picture coding apparatus in the first embodiment of the present invention;

FIG. 12 is still another illustration for describing a plurality of resources for computing included in the configuration of the motion picture coding apparatus in the first embodiment of the present invention;

FIG. 13 is a block diagram of a motion picture coding apparatus in the second embodiment of the present invention;

FIG. 14 is a block diagram of a coding unit in the second embodiment of the present invention;

FIG. 15 is a flowchart of the processings of the system management unit in the second embodiment of the present invention;

FIG. 16 is a flowchart of the processings of a system management unit in the third embodiment of the present invention;

FIG. 17 is a flowchart of the processings of a mode selection unit in the third embodiment of the present invention;

FIG. 18 is a flowchart of the processings of a system management unit in the fourth embodiment of the present invention;

FIG. 19 is a flowchart of the processings of a mode selection unit in the fourth embodiment of the present invention;

FIG. 20 is a configuration of resources for computing in the fourth embodiment of the present invention;

FIG. 21 is an illustration for describing how a macroblock is divided according to the present invention;

FIG. 22 is an illustration for describing what compose a macroblock;

FIG. 23 is a block diagram of a prior motion picture coding apparatus;

FIG. 24 is an illustration for describing the blocks in the DCT;

FIG. 25 is an illustration for describing coded adjacent pixels used for 4×4 intra-prediction;

FIG. 26 is an illustration for describing the principle of motion compensation; and

FIG. 27 is an illustration for describing the various of prediction types for motion compensation.

### DETAILED DESCRIPTION OF THE PREFERRED EMBODIMENTS

Hereunder, the preferred embodiments of the present invention will be described with reference to the accompanying drawings.

The present invention enables parallel distributed processings to be executed with use of a plurality of resources for computing to which both “motion search” and “mode selection” that require a long computing time to realize high quality images are allocated. The differential motion vector coding bits (the prediction motion vectors) and the residual macroblock estimation coding bits (the quantizer parameter) estimated by the execution of motion search and motion estimation are not necessarily the same as those of actual coding. Consequently, mode selection results (prediction type, reference frame index, and motion vector) is useful even when a candidate motion vector used for selecting a prediction motion vector belongs to a region allocated to another resource for computing, as well as even when controlling of quantizer parameters differs between mode selection processing and coding processing. This means that it is possible to execute both motion search and mode selection for different regions in parallel.

According to the present invention, data to be transmitted between two resources for computing is compressed before it is output to a network/bus so as to smooth the data access. Reference frames and reference information used for prediction are transmitted to a network/bus in coded data format, while input images, mode selection information and prediction/coding parameters are compressed with lossless coding method before they are transmitted to a network/bus. In that coding method, the data sender is required to have data compressing means while the data receiver is required to have data decoding means respectively. However, because the decoding time is far shorter than the mode selection time, it may be ignored. Using a simple data compression method will thus suppress problems that might occur otherwise from the processing time.

If the band in use is wide enough, it is possible to transmit raw data to a network without a data compression process.

Hereunder, the motion picture coding apparatus in the first embodiment will be described.

In the first embodiment, coding process is done mainly in the following four units; the control unit, the mode selection unit (intra-prediction, motion estimation, and mode selection), the coding unit (motion compensation unit, intra-prediction unit, DCT unit, quantizing unit, and VLC unit), and the local decoding unit (inverse quantizing unit, IDCT unit, motion compensation unit, intra-prediction unit, and frame memory). The control unit and the coding unit are allocated a resource for computing respectively while the mode selection unit is allocated a plurality of resources for computing. The local decoding unit that decodes reference frames and reference information from coded data is included in each resource for computing.

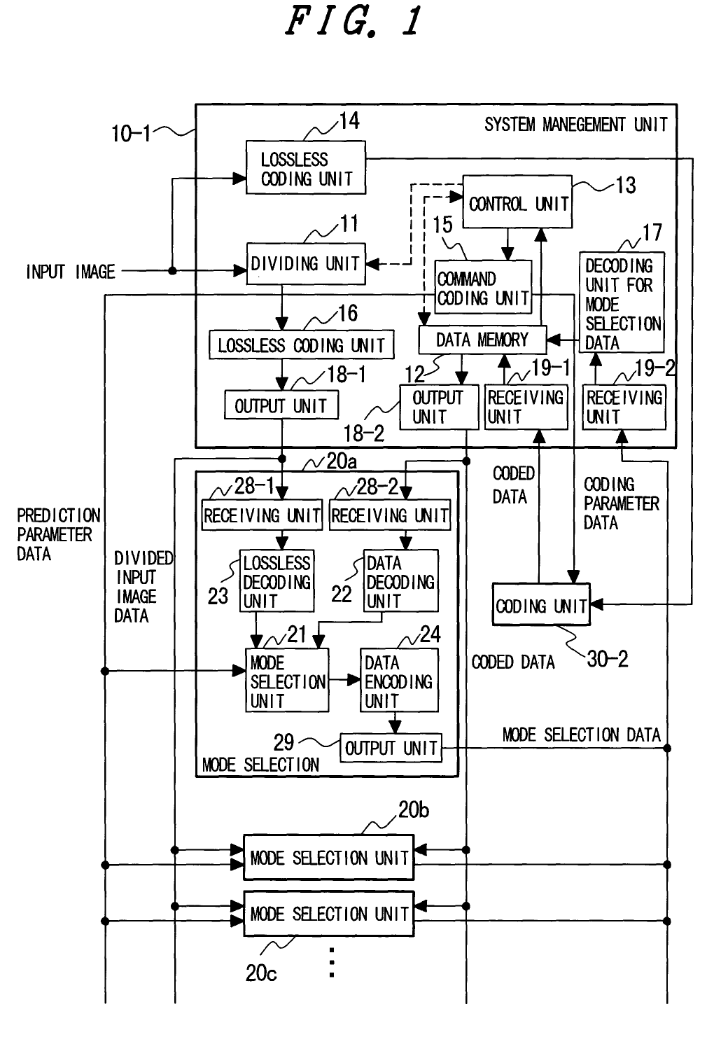

FIG. 1 shows a block diagram of the motion picture coding apparatus in the first embodiment. In FIG. 1, a resource for computing is allocated to the system management unit 10-1 and the coding unit 30-2 respectively and a plurality of resources for computing are allocated to the mode selection units 20a, 20b, 20c, . . . at a one-to-one correspondence.

In the system management unit 10-1, the dividing unit 11, when receiving an input image, divides the input image according to the command from the control unit 13.

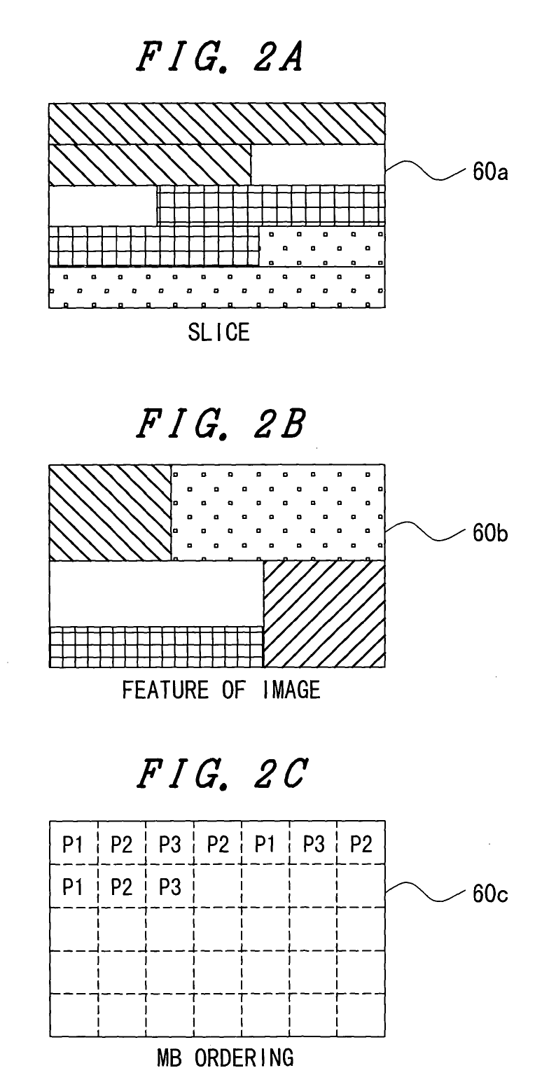

There are three methods for dividing an input image such way as shown in FIGS. 2A to 2C.

FIG. 2A shows a method for dividing an input image into slices and allocating each slice to a resource for computing. The input image is divided from the upper left to the lower right into slices that look like belt-like data items. No prediction can be made over slices, so that the match with algorithms for prediction, etc. is high in this case. FIG. 2B shows a method for dividing an input image into some regions based on the image features and allocating each region to a resource for computing; a specific region in the image is separated from others. The match with algorithms of prediction, etc. is low, but the method is easy to control quantizer parameters in this case. FIG. 2C shows a method for dividing an input image into macroblocks and allocating each divided macroblock to a resource for computing sequentially. P1 to P3 in FIG. 2C denote resources for computing. A resource for computing in which the processing in an allocated macroblock is completed firstly executes the processing in the next macroblock. Each dividing position in FIGS. 2A and 2B is decided by the control unit 13 according to the computing power of each resource for computing, the feature and the activity of each image.

An input image divided in the dividing unit 11 is coded in the lossless coding unit 16, then output to each mode selection unit 20 through the output unit 18-1 as divided input image data. There are many methods usable for such lossless coding, for example, the PCM coding of residual value generated by the execution of intra-prediction defined in the AVC, the lossless coding of JPEG2000 and so on. The region data output unit is configured so as to output divided input image data to each mode selection unit 20 from the lossless coding unit 16 through the output unit 18-1.

The coding in the lossless coding unit 16 may be lossy coding. When a lossy coding is used, the amount of output data can be reduced.

The control unit 13 outputs divided input image data and generates prediction parameters to be distributed to each mode selection unit 20. Those prediction parameters are used for motion search and mode selection and include a tentative quantizer parameter for calculating the estimated coding bits, limitation information and so on. The limitation information includes picture type (picture header, slice header, and sequence header), search range, selection inhibiting prediction type, parameters for converting coding bits to an error power value, target coding bits and so on. The tentative quantizer parameter is decided in consideration of the target coding bits and the features of each image region.

Prediction parameters are coded with lossless coding method in the command coding unit 15, then output to each mode selection unit 20 as prediction parameter data.

Each mode selection unit 20 receives inputs of divided image data, prediction parameter data, and coded data of previous frame. Each mode selection unit 20 detects mode selection information (prediction type, motion vector, reference frame index, estimated coding bits, quantizer parameter and so on) for each macroblock in divided input image distributed as divided input image data. And then, each mode selection unit 20 compresses it into mode selection data and outputs it to the system management unit 10-1. There are many methods usable for compressing data such way. For example, it may be a variable length coding method that uses a variable coding table defined in the AVC.

The mode selection data output from each mode selection unit 20 is transmitted to the system management unit 10-1. The system management unit 10-1, when receiving mode selection data through the receiving unit 19-2, decodes the received mode selection data to mode selection information in the decoding unit 17 and stores the decoded mode selection information in the data memory 12. The prediction mode receiving unit is configured so as to input mode selection data to the decoding unit 17 from each mode selection unit 20 through the receiving unit 19-2.

The control unit 13 then extracts estimated coding bits and quantizer parameters from the mode selection information stored in the data memory 12 to select quantizer parameters used for coding of each macroblock. At this time, the quantizer parameters are selected so as not to generate significant changes at flat parts in the input image in consideration of the differences between the estimated coding bits and the target coding bits. The selected quantizer parameters are put together with other parameters of prediction type, motion vector, reference frame, limitation information as coding parameters for each macroblock. The limitation information includes picture type (picture header, slice header, and sequence header) and quantizer design parameters (the range of quantizer DCT coefficient value that are not coded), etc.

Coding parameters of each macroblock are compressed to coding parameter data in the command coding unit 15 in the coding order and output to the coding unit 30-2 as needed. To compress the coding parameters of each macroblock, for example, a variable length coding method may be used. Coding parameters of a plurality of macroblocks may also be grouped in a unit of coding parameter data.

The system management unit 10-1 encodes input images in the lossless coding unit 14 and outputs the coded data to the coding unit 30-2. The lossless coding method used at unit 14 may be any of the method for coding each pixel residual value with PCM data according to a intra prediction type defined in the AVC intra, the JPEG2000 method for lossless coding, etc. as described above. The coding unit 30-2 generates coded data and outputs the coded data to the system management-unit 10-1. The coded data inputted through the receiving unit 19-1 of the system management unit 19-1 is stored in the data memory 12. The image data receiving unit is configured so as to input coded data to the receiving unit 19-1 from the coding unit 30-2.

The coded data stored in the data memory 12 is output to each mode selection unit 20 through the output unit 18-2. The coded data output unit is configured so as to output coded data to each mode selection unit 20 from the data memory 12 through the output unit 18-2.

This completes the coding of the input image.

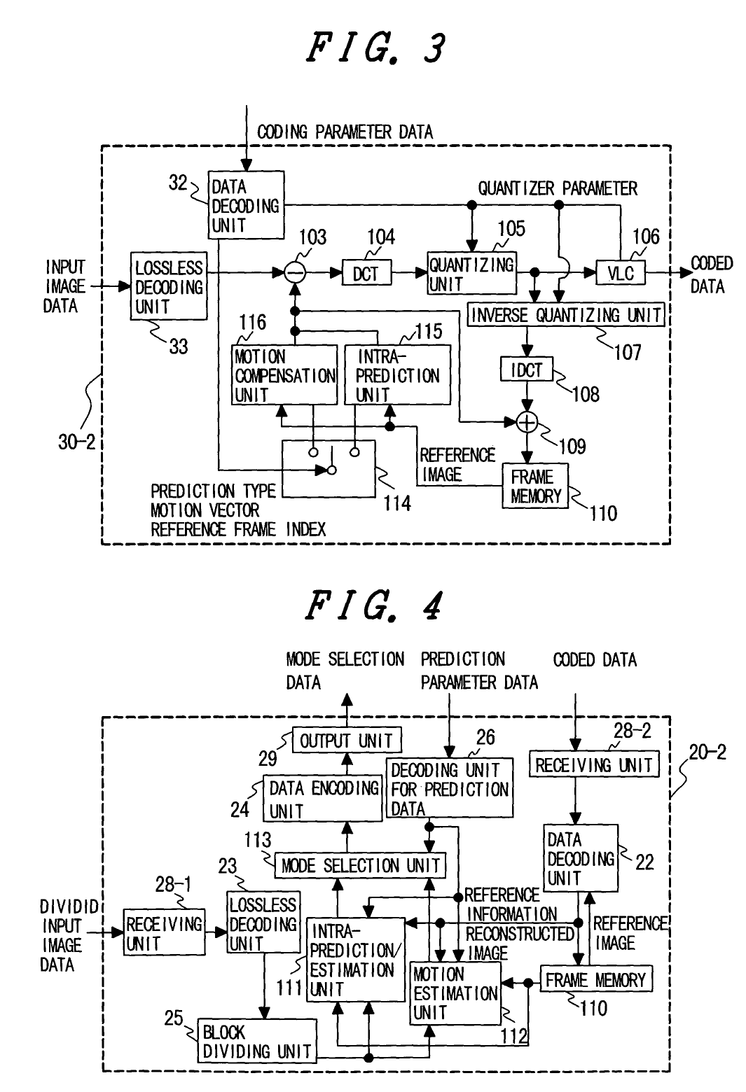

Next, the configuration of the coding unit 30-2 in the first embodiment will be described with reference to FIG. 3.

The coding unit 30-2 receives both image data and coding parameter data coded with the lossless coding method from the system management unit 10-1. The input image data is decoded in the lossless decoding unit 33 and the coding parameter data is decoded in the decoding unit 32. The lossless decoding unit 33 then divides the decoded input image into input macroblocks and inputs them to the subtraction processing unit 103 in order of coding.

The quantizer parameters and the quantizer design parameters decoded in the data decoding unit 32 are inputted to the quantizing unit 105 while the parameters of picture type, prediction type, reference frame index, and motion vector are inputted to the switcher 114.

The subtraction processing unit 103 receives an input macroblock, as well as a predictive macroblock generated in the intra-prediction unit 115 or motion compensation unit 116. And then, the unit 103 performs a subtraction processing for each pixel of both macroblocks to generate a residual macroblock and inputs the generated residual macroblock to the DCT unit 104. The DCT unit 104 transforms blocks in the residual macroblock to a plurality of DCT blocks. Those DCT blocks are output to the quantizing unit 105.

In the quantizing unit 105, transformation efficients in each DCT block is quantized to quantized DCT coefficients. These quantized DCT coefficients are output to the VLC unit 106 and coded there. At the same time, the quantized DCT coefficients are also output to the inverse quantizing unit 107. The inverse quantizing unit 107 de-quantizes the quantized DCT coefficients to reconstructed DCT coefficients to reconstruct to a DCT block. The reconstructed DCT blocks are output to the inverse DCT unit 108 to reconstruct a residual macroblock. The reconstructed residual macroblock is then inputted to the addition processing unit 109 together with a predictive macroblock generated in the intra-prediction unit 115 or motion compensation unit 116.

The addition processing unit 109 adds up pixels of both residual macroblock and predictive macroblock to generate a reconstructed macroblock. The reconstructed macroblock is stored in the frame memory 110.

The prediction type decoded and extracted from the coding parameter data is inputted to the intra-prediction unit 115 or motion compensation unit 116 through the switcher 114. The intra-prediction unit 115 or motion compensation unit 116 generates a predictive macroblock from the selected prediction type and the decoded adjacent pixels in current frame or reference frame stored in frame memory, then inputs the predictive macroblock to the subtraction processing unit 103.

The quantizer design parameters inputted to the quantizing unit 105 is used, for example, to set a range in which a quantized DCT coefficient is set to ‘0’.

Next, a description will be made for the configuration of the mode selection unit 20 in the first embodiment with reference to the block diagram shown in FIG. 4.

This mode selection unit 20 generates mode selection information (prediction type, motion vector, reference frame index, estimated coding bits, quantizer, etc.) for each macroblock using the divided input image data, the prediction parameter data and the coded data inputted from the system management unit 10-1. And then, the mode selection unit 20 compresses the mode selection information to mode selection data and outputs it to the system management unit 10-1.

The coded data inputted through the receiving unit 28-2 is decoded to a reconstructed image and reference information (prediction type, reference frame index, and motion vector) for each macroblock in the data decoding unit 22. The reconstructed image is stored in the frame memory as a reference frame while decoded reference information for each macroblock is inputted to and registered in the motion estimation unit 112 and the intra-prediction/estimation unit 111, since it is used for prediction. The coded data receiving unit is configured so as to input coded data to the data decoding unit 22 through the receiving unit 28-2.

The divided input image data inputted through the receiving unit 28-1 is decoded to divided input images in the lossless decoding unit 23. Decoded divided image is further divided into input macroblocks in the block dividing unit 25. The region data receiving unit is configured so as to input divided image data to the lossless decoding unit 23 through the receiving unit 28-1 and decided there.

The inputted prediction parameter data is decoded to prediction parameters for each macroblock in the prediction data decoding unit 26. The intra-prediction/estimation unit 111 and the motion estimation unit 112 generate a prediction candidate macroblock and an evaluation value (calculated from a prediction error power and estimated coding bits) of each candidate prediction type according to the prediction parameters to be described later. The prediction parameters include a tentative quantizer parameter used to calculate estimated coding bits decided by the control unit 13 in the system management unit (10-1 or 10-2) in consideration of the image feature, etc. And the prediction parameters include the limitation information (picture type, allocated region, search range, selection inhibiting prediction candidate type, parameter used to convert coding bits to an error power, and target coding bits), etc. The prediction candidate macroblock and the evaluation value generated by the intra-prediction/estimation unit 111 and the motion estimation unit 112 are output to mode selection unit 113 to select a prediction type as to be described later. The mode selection information (prediction type, motion vector, reference frame index, estimated coding bits, quantizer parameter, etc.) is output to the data code unit 24. The data code unit 24 then compresses the mode selection information to mode selection data, then outputs it to the system management unit 10-1 through the output unit 29. The prediction mode selection data output unit is configured so as to output mode selection data to the system management unit 10-1 through the output unit 29.

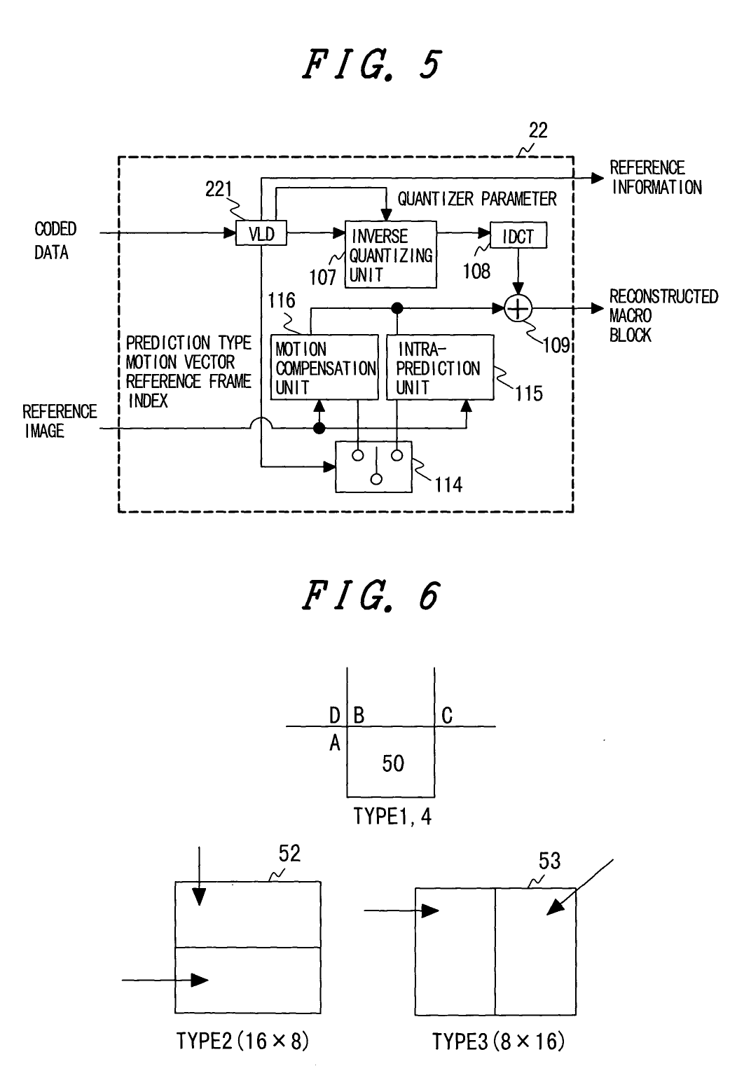

Next, the internal structure of a data decoding unit 22 will be described with reference to the block diagram in FIG. 5.

Coded data inputted from the system management unit 10-1 is decoded to quantizer parameters, a quantized DCT coefficient, and prediction information in the VLD unit 221. The quantizer parameters and the quantized DCT coefficients are then inputted to the inverse quantizing unit 107 while the prediction information (prediction type, reference frame number, and motion vector) is inputted to the switcher 114. At this time, the prediction information is also output to the motion estimation unit 111 and the intra-prediction/estimation unit 112 of the mode selection unit 20.

The switcher 114 decides either the intra-prediction unit 115 or motion compensation unit 116 as a destination to which the prediction information (prediction type, motion vector, and reference frame index) is output according to the received prediction type. The intra-prediction unit 115 or motion compensation unit 116 generates a predictive macroblock from the selected prediction type and the decoded adjacent pixels in current frame or reference frame stored in the frame memory (storage unit) 110, and outputs the predictive macroblock to the addition processing unit 109.

The inverse quantizing unit 107 and the inverse DCT unit 108 reconstruct a residual macroblock and output it to the addition processing unit 109. The addition processing unit 109 adds up the pixels of the predictive macroblock and the reconstructed residual macroblock to generate a reconstructed macroblock. The reconstructed macroblock is combined with a reconstructed image stored in the frame memory 110 of the mode selection unit 20.

Next, how to generate a predictive macroblock will be described.

As described above in the prior art, there are two methods for predicting pixels in a macroblock with use of pixels of a coded image; inter-prediction and intra-prediction.

How to generate predictive macroblocks differs among coding types of pictures (frames). There are three picture types; I-Picture applicable only for intra-prediction, P-Picture applicable for both intra-prediction and inter-prediction, and B-Picture applicable for intra-prediction and B type inter-prediction.

At first, the I-Picture type will be described.

The intra-prediction/estimation unit 111 is started up according to the picture information included in the limitation information received from the control unit 13 of the system management unit 10-1. The intra-prediction/estimation unit 111 receives an input macroblock from the block dividing unit 25 first. The intra-prediction/estimation unit 111 then generates a prediction candidate macroblock for each of the nine 4×4 intra types, the 4 16×16 intra types, and the four chroma-intra types with use of the coded adjacent pixels of current frame stored in the frame memory 110.

A subtraction processing between each generated prediction candidate macroblock and an input macroblock is executed to generate residual candidate macroblocks. A prediction error power and estimated coding bits are calculated from this residual candidate macroblock and the quantizer parameters in the limitation information. The generated estimated coding bits are converted to a corresponding value of estimated error power, which is then added to the estimated error power. The result is assumed as an evaluation value of the prediction candidate type. The evaluation value of the prediction candidate type is inputted to the mode selection unit 113 and a prediction candidate type that has the minimum evaluation value is selected as a prediction type of the target macroblock. The selected prediction type is transmitted to the coding unit 30-2, then a predictive macroblock is generated from it and the coded adjacent pixels of current frame stored in the frame memory 110.

Next, the P-Picture type will be described.

The intra-prediction/estimation unit 111 and the motion estimation unit 112 are started up according to the picture information included in the limitation information received from the control unit 13 of the system management unit 10-1. The processings of the intra-prediction/estimation unit 111 is the same as those of the I-Picture, so the explanation for the processings will be omitted here. The motion estimation unit 112, when receiving an input macroblock from the block dividing unit 25, estimates the motion of the macroblock in the following two steps.

In the first step, the motion estimation unit 112 selects an optimal pair of a reference frame and a motion vector for each of the three basic macroblock types and the sixteen extended macroblock types (four types of sub-block type combinations selected for each 8×8 block). Concretely, the motion estimation unit 112 searches and detects a pair of a reference frame and a motion vector that has the minimum evaluation value in the search range set for each reference frame with respect to each divided block in the macroblock. The motion estimation unit 112 uses only the luminance components in this search. And a search evaluation value is calculated by the use of the function of the sum of absolute value of the prediction error signal in the luminance component block, and the estimated coding bits of the movion vector and the reference frame.

In the second step, the motion estimation unit 112 generates a prediction candidate macroblock (including the chrominance components) and calculates the evaluation value for the nineteen macroblock types respectively with use of the pairs of selected reference frame and motion vector. A subtraction processing between each prediction candidate macroblock and the input macroblock is executed to generate residual candidate macroblocks. The motion estimation unit 112 then calculates both prediction error power and estimated error coding bits from this residual candidate macroblock and the quantizer parameters included in the limitation information.

An estimated coding bits of a motion vector and a reference frame index are added to the calculated estimated error coding bits, then the estimated error coding bits is converted to a corresponding value of the estimated error power. After that, the sum of the converted value and the estimated error power is assumed as the evaluation value of the prediction candidate macroblock. The evaluation values of prediction candidate macroblocks types are inputted to the mode selection unit 113. The mode selection unit 113 then selects a prediction type having the mininum evaluation value among a plurality of evaluation values received from the intra-prediction/estimation unit 111 and the motion estimation unit 112. After that, the mode selection unit 113 outputs the selected prediction type to the coding unit 30-2.

In the coding unit 30-2, the switcher 114 outputs prediction information (prediction type, motion vector, and reference frame index) to the intra-prediction unit 115 or motion compensation unit 116 according to the selected prediction type. The intra-prediction unit 115 or motion compensation unit 116 generates a predictive macroblock from the selected prediction type, the coded adjacent pixels in current frame or the reference frame stored in the frame memory.

The basic processing procedures of the B-Picture type are also the same as those of the P-Picture type. In the motion estimation in the first step, the motion estimation unit 112 detects a set of an optimal reference frame, a motion vector, and a prediction type (list 1/list 2/bi-predictive); not a pair of an optimal reference frame and a motion vector in that case. In the motion estimation in the second step, the direct prediction can be added to prediction type candidates.

The data (prediction type, motion vector, and reference frame number) required to generate a predictive macroblock as described above is coded together with quantized DCT coefficients in the VLC unit 106 of the coding unit 30-2. Hereinafter, how a motion vector is coded will be described. A detected motion vector itself is not coded here; instead, its differential value from a prediction motion vector is coded. The prediction motion vector is obtained from the motion vectors of its adjacent blocks.

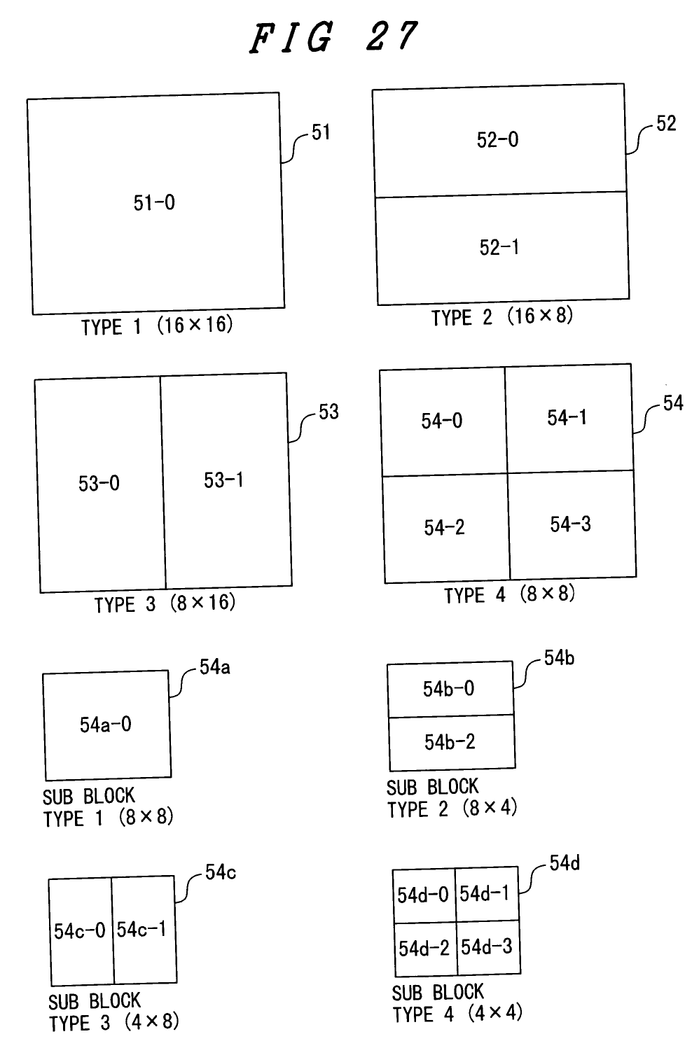

FIG. 6 shows a method for generating a prediction motion vector with use of the above-described motion compensation block type (FIG. 27). The same prediction method is used for the block 51-0 of type 1 shown in FIG. 27 and each sub-block. Assume here that there is a small block 50 for which a motion vector are to be coded. In this small block, the motion vectors of the three blocks indicated at A, B, and C adjacently are assumed as motion vector candidates and a mean value of them is selected. And, the motion vector having the mean value is assumed as the prediction motion vector. However, it might occur that the motion vector of block C is not coded or the block C is located out of the image due to the coding order and/or the positional relationship with the macroblock. In such a case, the motion vector of the block D is used as one of the candidate motion vectors instead of the block C.

If none of the blocks A to D has a motion vector, it is regarded as ‘0’ vector. If two of the three candidate blocks have no motion vector, the motion vector of the rest one block is regarded as the prediction vector. For the two small blocks (52-0 and 52-1) of the type 2 (52) and the two small blocks (53-0 and 53-1) of the type 3 (53), the motion vector of the block positioned at the root of the arrow shown in FIG. 6 is regarded as a prediction value of the motion. In any prediction type, the motion vector of chrominance components is not coded. Instead, the motion vector of each luminance component is divided into two, each of which is used as the motion vector of a chrominance component.

Actually, estimated coding bits of a residual candidate macroblock can be calculated with use of the functions of both DCT unit and quantizing unit, which are built in the intra-prediction/estimation unit 111 and the motion estimation unit 112 respectively. That would be the best way to obtain high quality images.

Since both of quantizer parameters and the estimated coding bits for calculating estimated coding bits are not necessary the same as those used for actual quantization and coding, they can thus be effectively estimated statistically from the characteristic of the prediction candidate macroblocks in consideration of the computing time. Similarly, the coding bits of the differential motion vector may not necessarily match with that used for actual coding as described above. When the motion vectors of the adjacent blocks are not decided yet, therefore, the estimated prediction motion vector may be used to estimate the coding bits of the differential motion vector.

In addition, if a selection inhibiting prediction candidate type is added to the limitation information, the mode selection can be limited. Those information items are effective for restricting the number of motion vectors, etc. required due to the limitation of product specifications, operation rules, etc., as well as when in applying the intra-prediction forcibly to an image region according to its characteristics.

Furthermore, if a parameter for converting coding bits to an error power is included in the limitation information, it is possible to change the relationship between the estimated error power and the coding bits when in calculating an evaluation value. This information is effective to execute the mode selection in consideration of the feature of each image. It is also effective to change the search range according to the image feature and specify the center point of a search range with limitation information to improve the quality of reconstructed images and reduce the computing cost.

The mode selection unit 113 compares the evaluation value of each prediction candidate type inputted from the motion estimation unit 112 and the intra-prediction/estimation unit 111 for each macroblock to select a prediction candidate type having the minimum value. The mode selection information (prediction type, motion vector, reference frame index, estimated coding bits, tentative quantizer parameter, etc.) related to the selected prediction type is coded in the data code unit 24, then output to the system management unit 10-1 as mode selection data. The mode selection data output unit comes to be configured so as to output mode selection data form the data code unit 24 through the output unit 29.

The tentative quantizer parameter can be modified effectively in the mode selection unit 20 according to a relationship between a sum of estimated coding bits for one mode selection resource for computing and the target coding bits.

And, because the closer the values of parameters between coding processing and mode selection processing are, the higher the prediction performance becomes, a method for executing motion search and mode selection separately in two steps will be effective. For example, intermediate results are collected in the system management unit once, then the prediction parameters (especially, the quantizer parameters) are tuning so that the quality of whole image can be high and execute both motion search and mode selection finally. In that connection, such a variable length coding method that uses a variable length coding table defined in the AVC is used to compress the mode selection information.

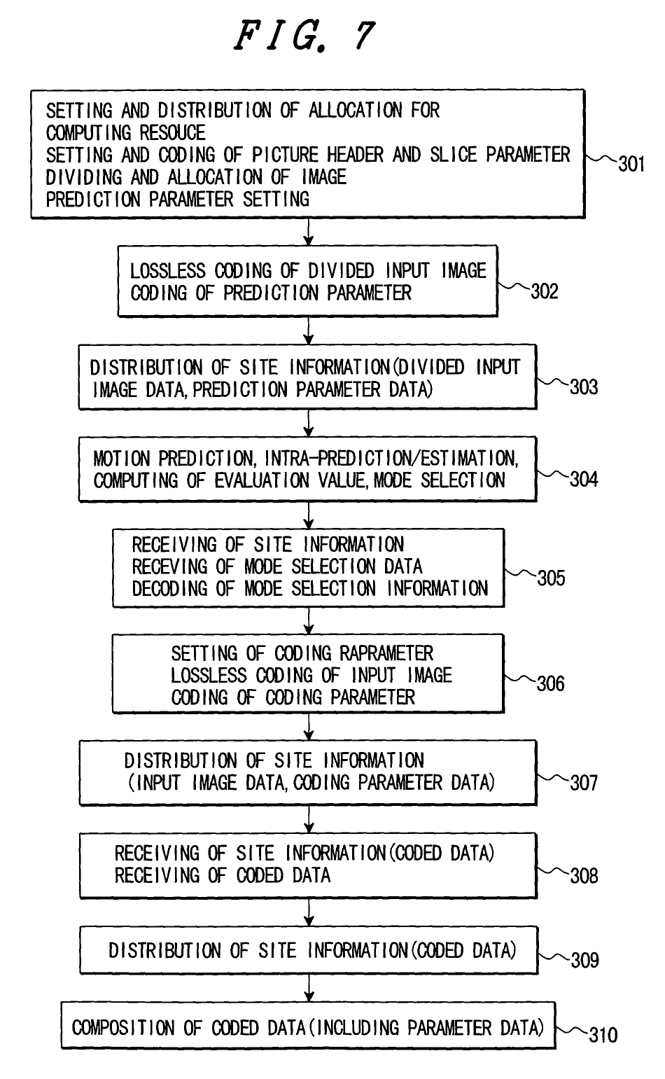

Next, the processings of the system management unit 10-1 in the first embodiment will be described with reference to the flowchart shown in FIG. 7.

At first, the system management unit 10-1 executes the following four processings (step 301) at the initialization time.

1) Setting and distribution of allocation for each resource for computing

2) Setting and coding picture header and slice header information

3) Dividing an input image into regions and allocating each divided region to a mode selection unit 20

4) Setting prediction parameters

In the prediction parameters are included a quantizer parameter and limitation information (picture type, picture header, slice header, allocated region, search range, selection inhibiting prediction candidate type, parameter for converting coding bits to an error power, target coding bits, etc.). The prediction parameters are updated in consideration of the feature of each image region, etc. In the first frame, the prediction parameters include a sequence header.

Then, the system management unit 10-1 executes the lossless coding for each divided input image and the coding of prediction parameters (step 302). Coded data generated in those processings is stored in its predetermined unit (ex., data memory unit 12).

After that, the system management unit 10-1 distributes the site information (ex., such data storing unit information as an address) of lossless-coded divided input image data and coded prediction parameter data (step 303) to each mode selection unit 20 (each mode selection resource for computing). These data can be sent to each resource for computing in real time. However, because the processing time differs among the resources for computing, the system management unit 10-1 distributes the site information to each mode selection unit 20 and each resource for computing obtains coded data at its given timing in this embodiment.

While each mode selection unit 20 executes its processing, the processing load of the system management unit 10-1 is reduced accordingly, thereby the system management unit 10-1 is allowed to execute another processing. For example, the system management unit 10-1 has a function of mode selection (equivalent to those of the lossless decoding unit, the data decoding unit, the mode selection unit, the data code unit, etc.) to execute mode selections for some image regions in such a case (step 304).

When each mode selection unit 20 completes its processing, the system management unit 10-1 receives the site information of mode selection data from each computing resource for mode selection and then the unit 10-1 downloads mode selection data. The system management unit 10-1 then decodes mode selection data to the mode selection information of each macroblock (step 305). This mode selection information includes prediction type, motion vector, reference frame number, quantizer parameter, and estimated coding bits.

After that, the system management unit 10-1 sets the coding parameters for each macroblock and executes the lossless coding of the input image and the coding of coding parameters (step 306). The coding parameter includes quantizer parameter, prediction type, motion vector, reference frame, and limitation information (picture type, picture header, slice header, quantizer design parameter) The quantizer parameter is updated for each frame in consideration of the target bit rate, the image activity, etc. In the first frame, the coding parameter includes a sequence header.

The site information of the input image data and the coding parameter data is distributed to the coding unit 30-2 (step 307).

When the coding unit 30-2 completes its processing, the system management unit 10-1 receives the site information of the coded data of the current frame from the coding unit 30-2, then downloads the coded data (step 308).

The site information of coded data is distributed to each mode selection unit 20 (step 309). Finally, the coded data of current frame is combined with the coded data of the whole sequence (step 310).

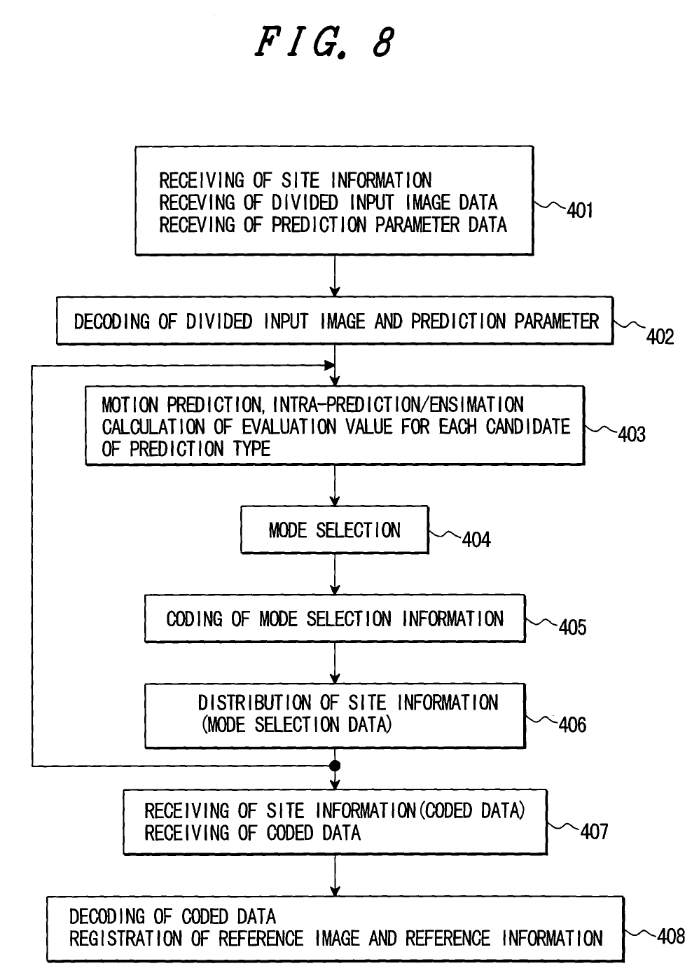

Next, the processings of the mode selection unit 20 will be described with reference to the flowchart shown in FIG. 8.

At first, the mode selection unit 20 receives the site information of the divided input image data and the prediction parameter data distributed in step 303 shown in FIG. 7 to download each of the data (step 401).

Then, the mode selection unit 20 decodes the divided input image data and the prediction parameter data downloaded in step 401 to obtain divided input image regions and prediction parameters, which are then divided for each macroblock (step 402).

After that, the mode selection unit 20 executes processings of motion estimation and intra-prediction/estimation to calculate the evaluation value of each candidate prediction type with use of those data and the reference frame (stored in the frame memory 110, for example) (step 403).

The mode selection unit 20 then selects a prediction type of each macroblock in a divided region (step 404).

The mode selection unit 20 then generates the mode selection information of each macroblock according to the selected prediction type and encodes the mode selection information to generate mode selection data (step 405). This mode selection data is stored in a predetermined unit (ex., the frame memory 110) of the mode selection unit 20.

The site information of the stored mode selection data is distributed to the system management unit 10-1 (step 406).

After that, the mode selection unit 20 receives the site information of the coded data distributed in step 309 shown in FIG. 7 to download the coded data (step 407).

The mode selection unit 20 decodes the coded data (in the data decoding unit 22, for example), then stores the reference frame and the reference information in a specific unit (ex., the frame memory 110) to use them for coding the next frame (step 408).

The processings in steps 403 and 404 can be done again by using the updated quantizer parameters fed back from the system management unit 10-1. When in this feedback processing, the encoding complexity can be reduced if the motion search is omitted and only the estimated coding bits are calculated. The processings in steps 403 and 404 may be done in two steps in which an intermediate result is collected in the system management unit 10-1, then the prediction parameter is modified slightly so as to decide the final prediction type. Such way, this embodiment of the present invention can apply to various algorithms for improving the image quality.

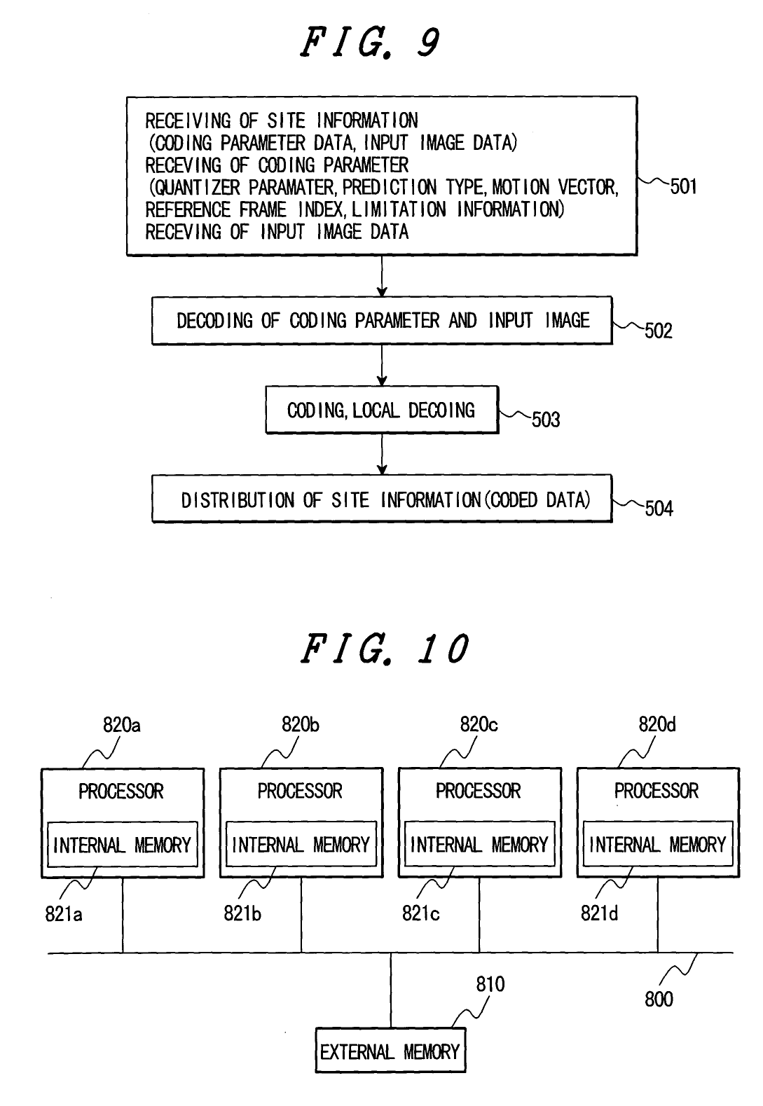

Next, the processing flow in the coding unit 30-2 will be described with reference to the flowchart shown in FIG. 9.

At first, the coding unit 30-2 receives the site information of both coding parameter data and input image data from the system management unit 10-1 (step 501).

Then, the coding unit 30-2 decodes the coding parameter data to coding parameters and the input image data to an input image (step 502).

The coding unit 30-2 then codes each macroblock according to the coding parameters. At this time, the coding unit 30-2 also executes local decoding to store both reference frame and reference information (step 503).

Finally, the coding unit 30-2 distributes the site information of the coded data to the system management unit 10-1 (step 504).

Next, how resources for computing are used in the first embodiment of the present invention will be described.

FIG. 10 shows a block diagram of a multi-core processor configured by a plurality of processors equivalent to the resources for computing in the motion picture coding apparatus shown in FIG. 1.

A multi-core processor is a computing apparatus that has a plurality of processors, each having an internal memory. And, each of the processors is used as a resource for computing. Concretely, as shown in FIG. 10, a multi-core processor is configured by an external memory 810 connected to a bus and used as a memory controllable with programs and instructions, a plurality of processors (820a to 820d) used for control processings as the resources for computing, and a plurality of internal memories (821a to 821d) built in those processors respectively.

The processor 820a is used like the system management unit 10-1 while the processors 820b and 820c are used like the mode selection units 20 and the processor 820d is used like the coding unit 30-2 while some parts of coding processing are shared among the processors. In such a multi-core processor, it is specially programmed so that common data (reference frames, reference information, and coded data) that must be generated by the plurality of resources for computing is stored in the external memory 810. Consequently, only one of the processors is allowed to generate such common data. In this configuration of the multi-core processor, each resource for computing can be replaced with another regardless of the type frame by frame.

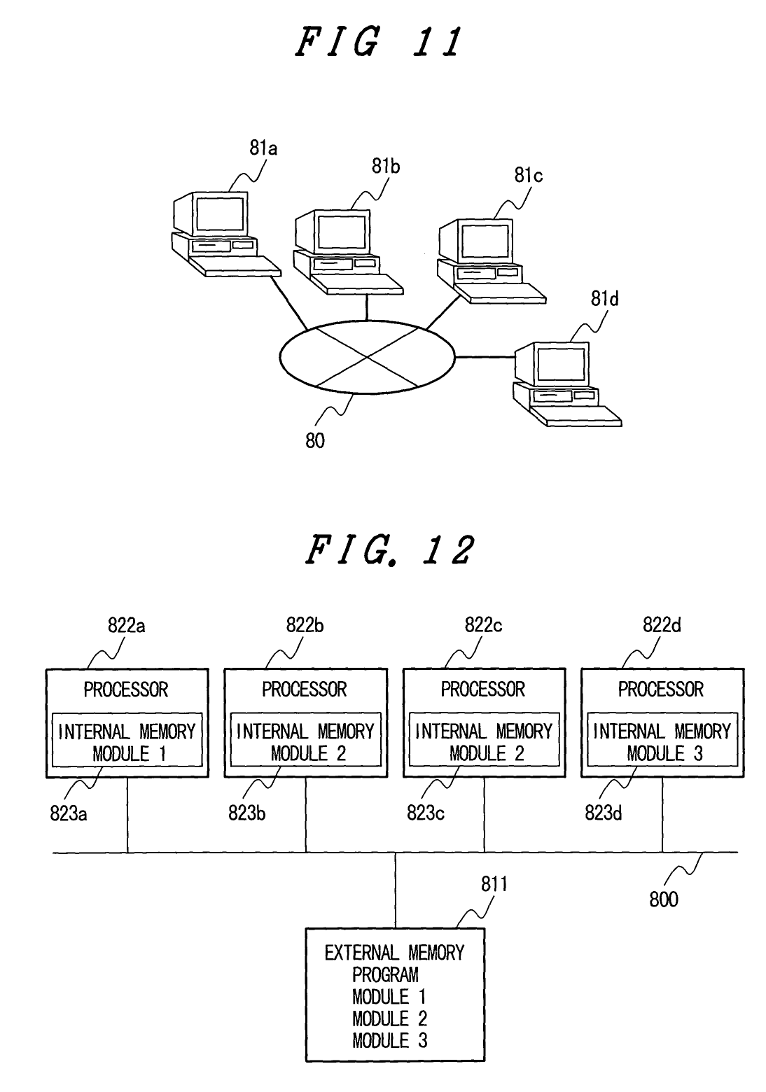

FIG. 11 shows another block diagram of the motion picture coding apparatus shown in FIG. 1, which is configured by a plurality of computers 81a to 81d (resources for computing) connected to a network. The computer 81a is used as a system management unit, the computers 81b and 81c are used as mode selection units, and the computer 81d is used as a coding unit. Those resources for computing (computers) are connected to each another for communications through a network 80.

FIG. 12 shows still another block diagram of the motion picture coding apparatus shown in FIG. 1, which is configured with use of a program package.

The program package consists of program modules. The program package can be installed in each resource for computing beforehand or can be installed in a specific resource for computing and only a required program module is distributed to each of other resources for computing.

At first, the program package is installed in the processor 822a. The processor 822a stores execution modules in the external memory 811 according to the initialization process registered in the program package. The execution modules (equivalent to the functions of the system management unit, the mode selection unit, and the coding unit) are programs used for executing processings. The processor 822a that functions as the system management unit installs the module 1 in the internal memory 823a. After that, the processor 822a installs a necessary module to each processor according to the workload shared by the processor. Each of other processors 822b to 822c executes the installed module.

If computers are connected to each another through a network as shown in FIG. 11, the computer in which the program package is installed initializes the coding process and installs one or all of the necessary modules to other computers. Consequently, there is no need to install any program in each of the computers beforehand and processings are executed in those computers as needed.

As described above, because the motion picture coding apparatus in the first embodiment is provided with the system management unit 10-1 for managing the whole system, a plurality of mode selection units (20a, 20b, 20c, . . . ) for selecting a prediction type respectively, and a coding unit 30-2 for coding data, the apparatus can execute selection of prediction types in parallel while such a mode selection has taken much computing time, thereby the apparatus can code input images more efficiently. In addition, coded data is transferred between resources for computing, the network and the bus can be used efficiently to improve the processing efficiency of the whole system.

Next, the second embodiment of the present invention will be described.

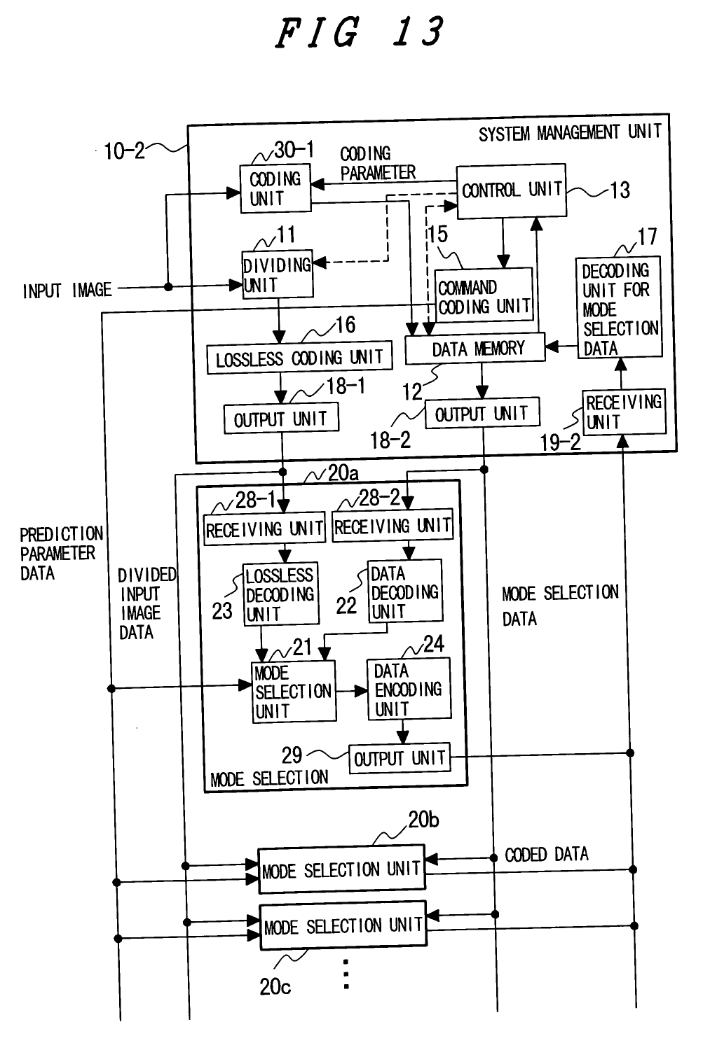

FIG. 13 shows a block diagram of a motion picture coding apparatus in this second embodiment.

Unlike the first embodiment, the workload differs among resources for computing in this second embodiment. Concretely, a coding unit 30-1 is included in the system management unit 10-2 and one resource for computing is used for both system management and coding. While the system management unit 10-1 compresses an input image in the lossless coding and outputs the coded input image to the coding unit 30-2 in the first embodiment, the system management unit 10-2 makes no lossless compression for an input image to be inputted to the coding unit 30-1. The coding unit 30-1 encodes an input image and stores coded data in the data memory 12. In this second embodiment, the same reference numerals are used for the same functional items as those in the first embodiment, avoiding redundant description.

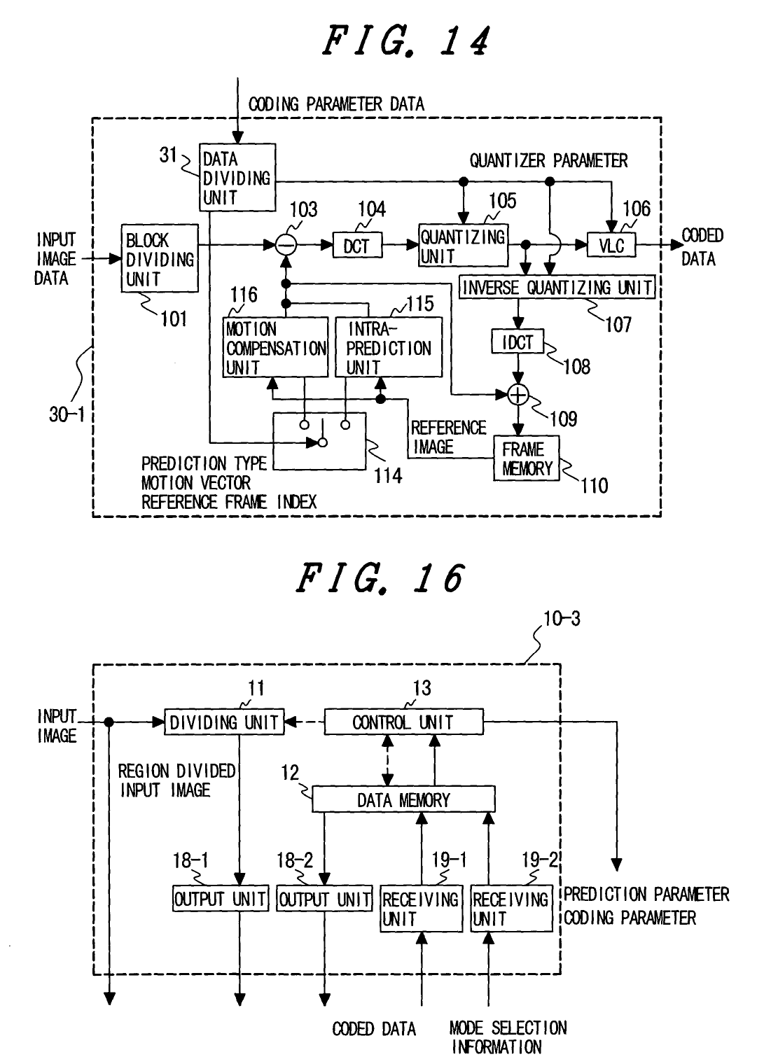

Next, a configuration of the coding unit 30-1 in this second embodiment will be described with reference to the block diagram shown in FIG. 14.

The coding unit 30-1 receives an input image and coding parameters that are not compressed. Consequently, the coding unit 30-1 in this second embodiment is modified from the coding unit 30-2 in the first embodiment (FIG. 3) as follows; the lossless decoding unit 33 is replaced with a block dividing unit 101 and the data decoding unit 32 is replaced with a data dividing unit 31 respectively.

An input image inputted to the block dividing unit 101 is divided into macroblocks and output to the subtraction processing unit 103 in order of coding. Coding parameters inputted to the data dividing unit 31 are distributed as follows; the quantizer parameters and the quantizer design parameters are inputted to the quantizing unit 105 while the picture type, the prediction type, the reference frame index, and the motion vector are inputted to the switcher 114. Hereinafter, the processings are the same as those of the coding unit 30-2 (FIG. 3) in the first embodiment, so the description for the processings will be omitted here.

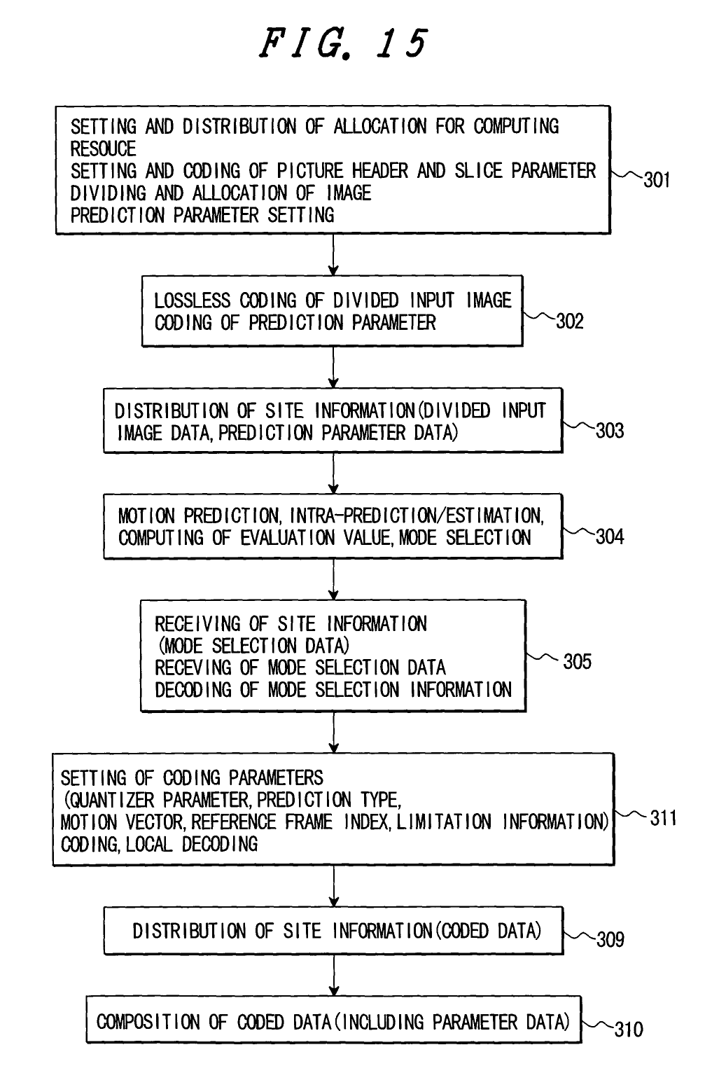

Next, the processings of the system management unit 10-2 in the second embodiment will be described with reference to the flowchart shown in FIG. 15. The description for the same numbered processings as those in FIG. 7 will be omitted here.

After decoding the mode selection data in step 305, the system management unit 10-2 sets coding parameters for each macroblock and encodes an input image according to the coding parameters in step 311. At the same time, the system management unit 10-2 executes local decoding of coded data to store both reference frame and reference information in a specific unit (ex., the data memory 12).

If the motion picture coding apparatus in the second embodiment is configured by a multi-core processor as shown in FIG. 10, the data in the frame memory of the coding unit 30-1 may be programmed so that it is stored in the external memory 810. Then, the local decoding in each mode selection unit can be omitted. However, because the access speed of the external memory 810 is slower than that of the internal memory 821, much care should be paid to use each of the memories 810 and 821 properly.

If the motion picture coding apparatus is configured by a plurality of computers connected to a network as shown in FIG. 11, the computer 81a is used as the system management unit, the computers 81b to 81d are used as the mode selection units.

In the above configuration, it is possible to replace the work of any resource for computing with that of another for each frame regardless of the type of the resource.

As described above, the motion picture coding apparatus in the second embodiment can obtain an effect for reducing a network/bus cost in addition to the effect of the first embodiment. Thereby, the apparatus can improve its processing efficiency as a whole when a resource for computing having comparatively less workload in the system management unit includes the coding unit 30-1.

Next, the third embodiment of the present invention will be described.

In the first and second embodiments, data is compressed (coded), then it is transmitted to a network or bus to smooth the data accesses between the resources for computing. However, if the network/bus band is wide enough to transmit data between those resources, data may not be compressed (coded) before it is transmitted to the network/bus. Consequently, coding and decoding of data can be omitted, thereby the system processing is speeded up significantly.

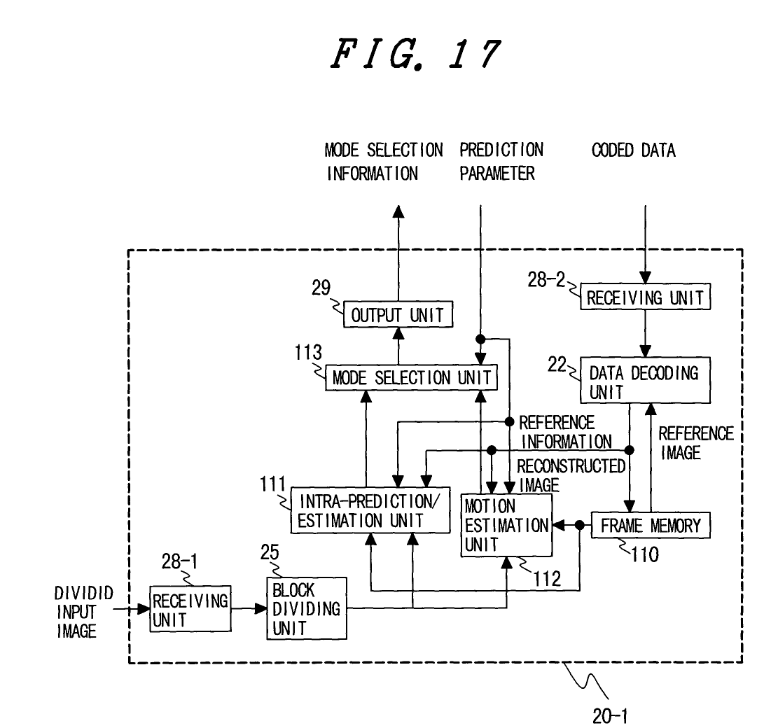

Therefore, the system management unit 10-1 in first embodiment (FIG. 1) or 10-2 in second embodiment (FIG. 13) and the mode selection unit 20-2 (FIG. 4) in the first and second embodiments are replaced with a system management unit 10-3 (FIG. 16) and a mode selection unit 20-1 (FIG. 17) respectively in this third embodiment.

The resources for computing have none of the lossless coding unit (16 in FIG. 1), the data code unit (24 in FIG. 1) and the lossless decoding unit (23 in FIG. 1). And, the processings other than the coding and decoding are the same as those in the first and second embodiments, so the description for them will be omitted here.

As described above, the third embodiment can obtain the effects of the first or second embodiment, as well as another effect that the system processing is speeded up, since data is not compressed (coded) before it is transmitted between resources for computing when the network/bus band is wide enough. Thereby, coding and decoding for the generation of compressed data is omitted.

Next, the fourth embodiment of the present invention will be described. In this embodiment, data is coded in a mobile communication terminal (ex., a portable telephone).

In this fourth embodiment, the system is configured in two ways. In one way, one portable telephone is used as a multi-core processor to configure the system. In the other way, more than two portable telephones are used to configure a motion picture coding apparatus.

At first, the former configuration will be described. The portable telephone is configured so as to slow the bus speed (narrow the line band) to save the power consumption. So, it is necessary to reduce the number of data accesses to keep the processing speed fast. To achieve this object, the parallel processing to be shared among a plurality of resources for computing is limited to reduce the number of data accesses. For example, only motion searching is distributed to a plurality of processors, since it takes the most computing time among system processings. In this connection, both intra-prediction and mode selection had better be done in the system management unit.

In the latter configuration in which an input image is coded by using some reference frames as the candidates of motion search, it is effective to allocate a whole frame to each resource for computing instead of any part of divided input images. This method makes it possible to reduce the computing cost for local decoding in the mode selection resources by using the internal memories efficiently.

Assume now that the fourth frame is the current input image, there are three candidate reference frames, and there are three processors used for mode selection. Then, the coded data of the first frame is decoded locally only in the first processor, the coded data of the second frame is decoded locally only in the second processor, and the coded data of the third frame is decoded locally only in the third processor. And, the fourth frame (input image) is stored in the external memory and the input image of each macroblock is distributed to each processor. When in the motion search or mode selection of the fourth frame, the first to third frames are allocated to the first to third processors as reference frames respectively. The system management unit (fourth processor), when receiving the mode selection information related to each reference frame, selects both of the final prediction type and the final reference frame for each macroblock and requests the processor that stores the finally selected reference frame for a predictive macroblock or residual macroblock.

The predictive macroblock or residual macroblock can be included in the mode selection information when the mode selection information is transmitted to the system management unit from each processor for mode selection. Each processor may process more than one frame and the intra-prediction may be executed in one or a plurality of processors.

The coded data of the fourth frame is decoded locally only in the first processor before the fifth frame is coded. Repeating those processings, the number of reference frames to be stored in the internal memory of each processor can be reduced to only one.

Next, the processings of the fourth embodiment will be described.

The first mode selection is done for each reference frame and the second mode selection is done for all candidate reference frames to decide an optimal set of a prediction type, a reference frame, and motion vectors.

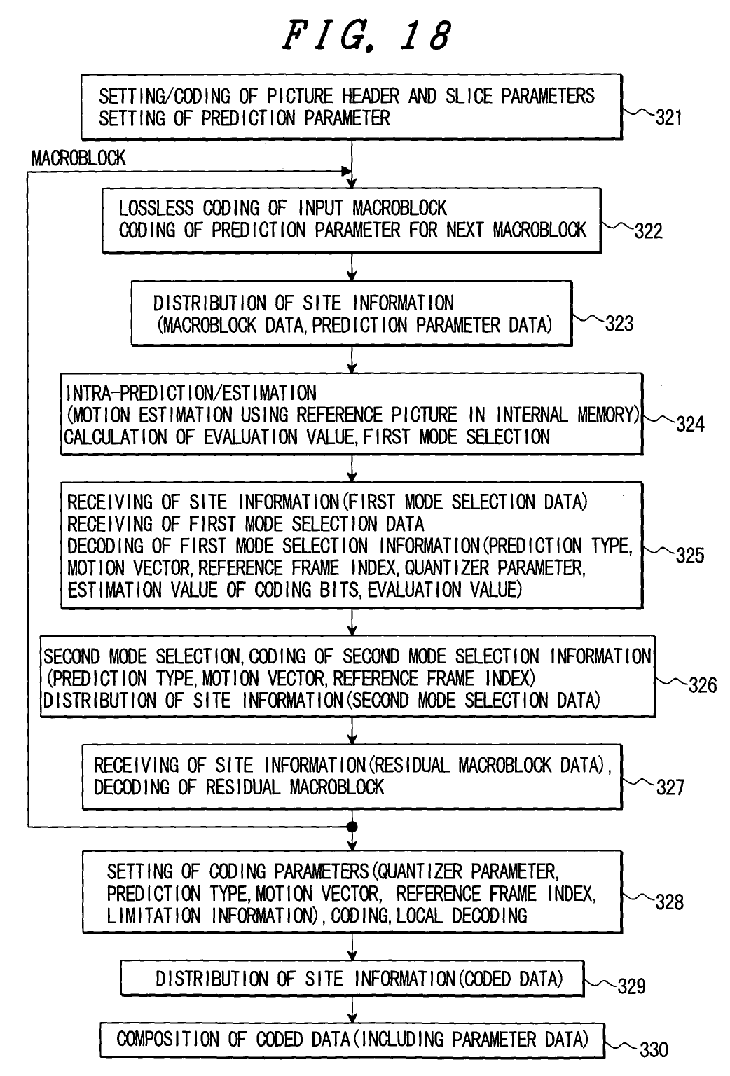

FIG. 18 shows a flowchart of the processings of the system management unit 10-2. In this fourth embodiment, the system management unit 10-2 is premised to include a coding unit 30-1.

The system management unit 10-2 executes the following processings for each frame as the initialization (step 321).

1.) Setting and coding information of both picture header (the sequence header in the first picture) and slice header

2) Setting prediction parameters Prediction parameters are set just like in step 301 of the flowchart shown in FIG. 7. In this fourth embodiment, however, processings are done for each macroblock, so that the prediction parameters can be updated for each macroblock. Consequently, the processings in steps 322 to 327 are executed for each macroblock.

Then, the system management unit 10-2 executes the lossless coding of next input macroblock and coding of the prediction parameters for the next macroblock (step 322).

The system management unit 10-2 then distributes the site information of the macroblock data and the prediction parameters to each mode selection unit (step 323). While each mode selection unit executes the motion estimation of the reference frame stored in its internal memory, the system management unit 10-2 executes intra-prediction/estimation to calculate the evaluation value of each candidate intra-prediction type. The system management unit 10-2 then decides the optimal intra-prediction type in the first mode selection.

The system management resource may execute the motion estimation for one reference frame, here.

Each mode selection unit, when completing a processing, distributes the site information of the first mode selection data to the system management unit 10-2. The system management unit 10-2, when receiving the site information, takes the first mode selection data of each reference frame and decodes the first mode selection data to the first mode selection information (prediction type, motion vector, reference frame index, quantizer parameter, estimated coding bits, and evaluation value) (step 325).

At this time, the system management unit 10-2 executes the second mode selection to decide the final prediction type for the input macroblock. Concretely, the system management unit 10-2 selects the optimal prediction type by comparing the evaluation value included in the first mode selection information of each reference frame and the intra-prediction. The system management unit 10-2 then codes the prediction type, the motion vector, and the reference frame index that are selected (both motion vector and reference frame are not included when an intra-prediction type is selected) as the second mode selection information. And then, the system management unit distributes the site information to each mode selection unit as the second mode selection data (step 326).

When each mode selection unit ends its processing, the system management unit 10-2 receives the site information of the residual macroblock data, then receives and decodes the residual macroblock (step 327). If the first mode selection of selected prediction type is executed in the system management unit 10-2, this step 327 is omitted.

After completing the processings in steps 322 to 327 for all the macroblocks, the system management unit 10-2 sets the coding parameters for each macroblock and codes the macroblock according to the coding parameters to generate coded data. At the same time, the system management unit 10-2 decodes the macroblock locally to store both reference frame and reference information in its memory (step 328).

The system management unit 10-2 then distributes the site information of the coded data generated in step 328 to each mode selection resource (step 329), then combines the coded data of the current frame with the coded data of the whole sequence (step 330). The processings in steps 328 to 330 can be executed without waiting for completion of the processings of all the macroblocks, since the processings can be started at a macroblock in which the second mode information and the residual macroblock are received. In that connection, the data composition in step 330 includes the coded data composition of each macroblock.

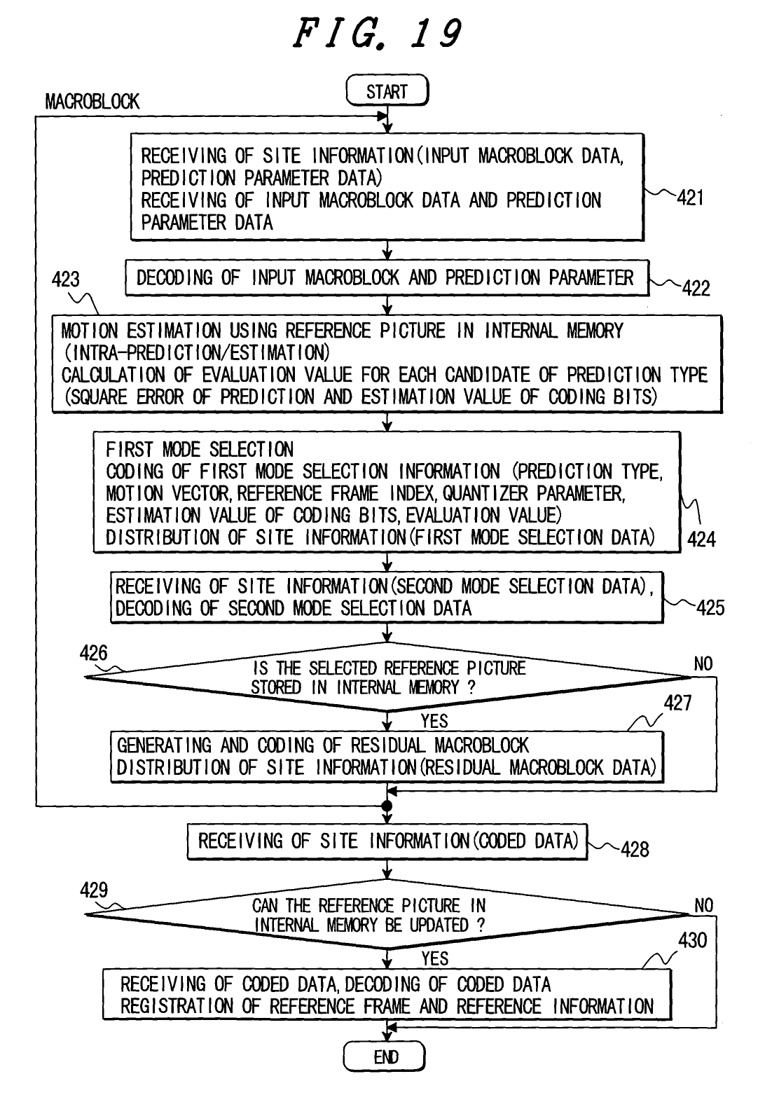

Next, the processings of the mode selection unit 20 will be described with reference to FIG. 19.

Mode selection processings are roughly classified into the processings in steps 421 to 427 to be executed for each macroblock and the processings in steps 428 to 430 to be executed for each frame.

At first, the mode selection unit 20 receives the site information of the input macroblock data and prediction parameter data, and it receives input macroblock data and prediction parameter (step 421).

Then, the mode selection unit 20 decodes both of the input macroblock and the prediction parameter data to both input macroblock and prediction parameters (step 422).

After that, the mode selection unit 20 executes the motion estimation for the reference frame stored in its internal memory to calculate the evaluation value of each candidate of prediction type (step 423).

The mode selection unit 20 then executes the first mode selection, which decides an optimal motion prediction type for the reference frame stored in its internal memory. According to the selected prediction type, the mode selection unit 20 generates the first mode section information (prediction type, motion vector, reference frame index, quantizer parameter, estimated coding bits, and evaluation value), then codes the first mode section information to the first mode selection data. After that, the mode selection unit 20 distributes the site information of the first mode selection data to the system management unit (step 424).

The mode selection unit 20 then receives the second mode selection data according to the site information received from the system management unit and decodes the second mode selection data (step 425).

After that, the mode selection unit 20 decides whether or not the reference frame indicated in the decoded second mode selection information matches with the reference frame stored in the internal memory (step 426). If the decision result is YES (match), the mode selection unit 20 generates a residual macroblock from both second mode selection information and reference frame, then codes the macroblock to residual macroblock data. The mode selection unit 20 then distributes the site information of the residual macroblock to the system management unit (step 427). These processings in steps 421 to 427 are executed for each macroblock in the input image.

The processings in steps 422 to 424 can be executed again by using the updated quantizer parameter fed back from the system management unit. In that connection, if only the estimated coding bits are calculated without doing motion search when in the feed-back, the encoding complexity can be reduced. And, just like the processings shown in the flowchart in FIG. 7, the processings may be executed in two steps so that an intermediate processing result is collected to the system management unit and the prediction parameter data is modified slightly, then the final prediction type is decided.

The mode selection unit 20 then receives the site information of the coded data (step 428).

The mode selection unit 20 then decides whether or not it is possible to update the reference frames stored in the internal memory in order of coding (step 429). If the decision result is YES (possible), the mode selection unit 20 takes the coded data from the information site, then decodes the data and replaces it with the stored reference frame (step 430).

While the system management unit evaluates each intra-prediction type in the above description, a specific mode selection unit may evaluate the intra-prediction type or each mode selection unit shares the evaluation with others. If the processing ability is almost equal (almost no difference) among the resources for computing, the evaluation had better be shared by them. That will be effective to improve the system processing efficiency.

While only one reference frame is stored in the internal memory of each mode selection unit in the above description, two or more reference frames can be stored therein.

Next, a description will be made for a case in which the motion picture coding apparatus of the present invention is configured by a plurality of portable telephones. In this connection, communications between terminals are made with such a communication method as Bluetooth, infrared ray communication, etc. that do not use any portable telephone network (the method may be a wired communication one). That will enable local processings.

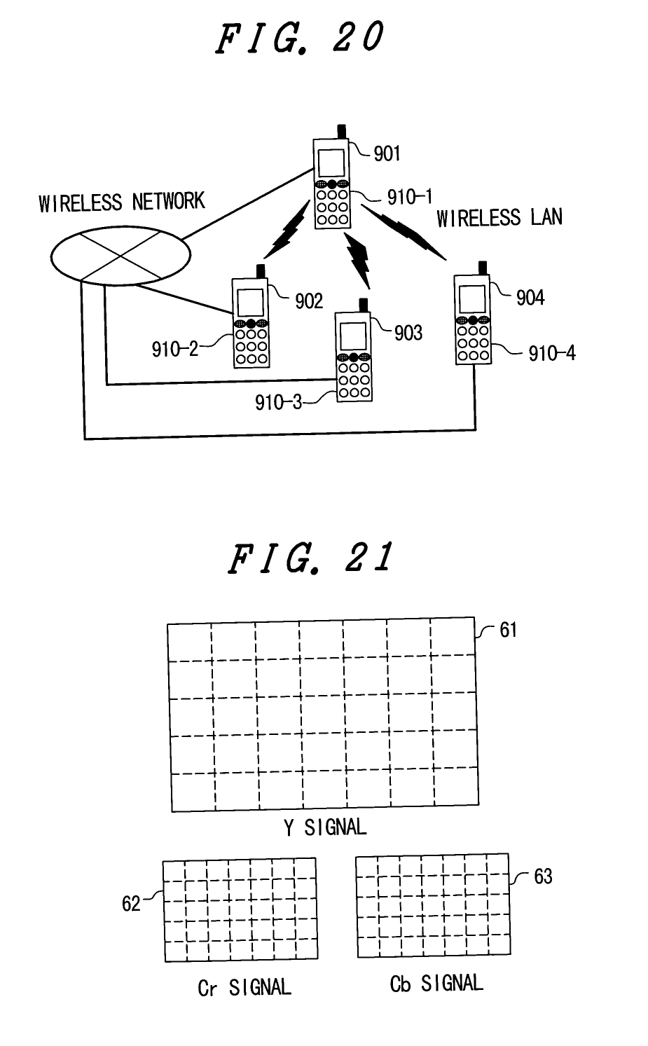

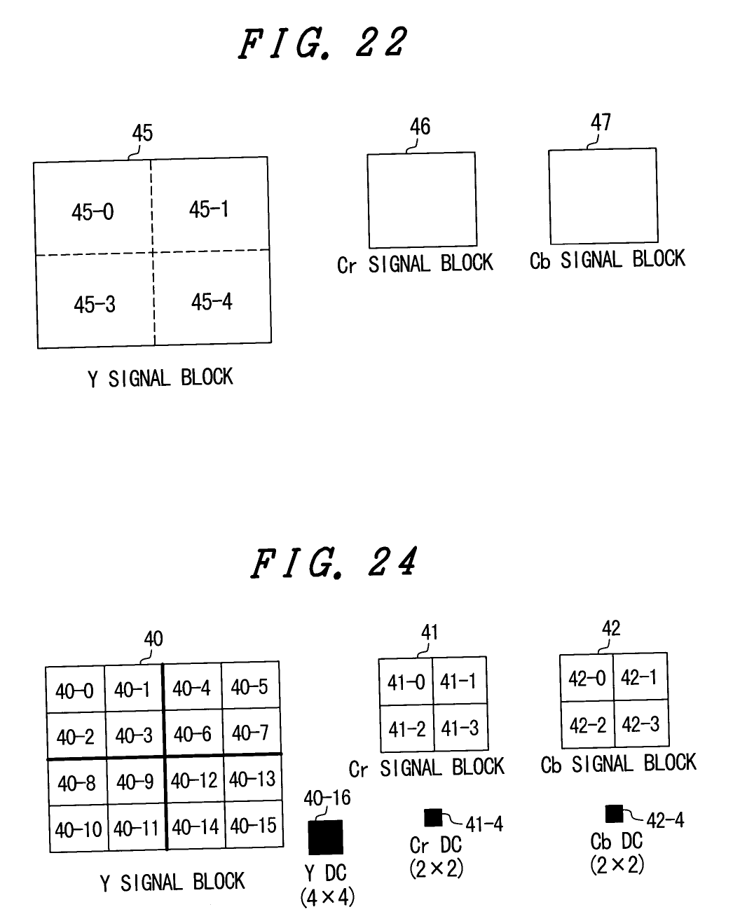

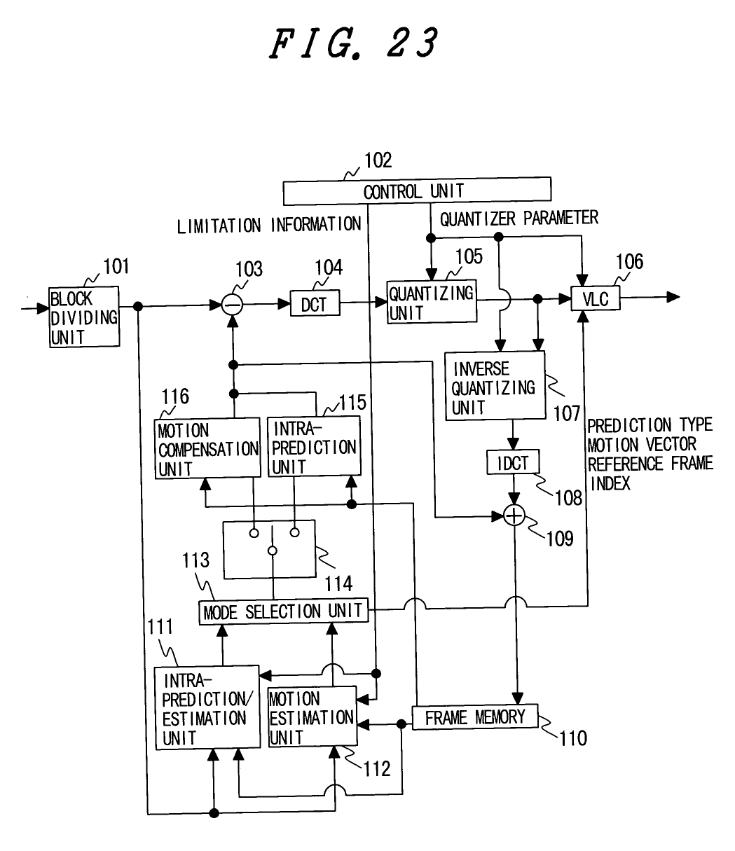

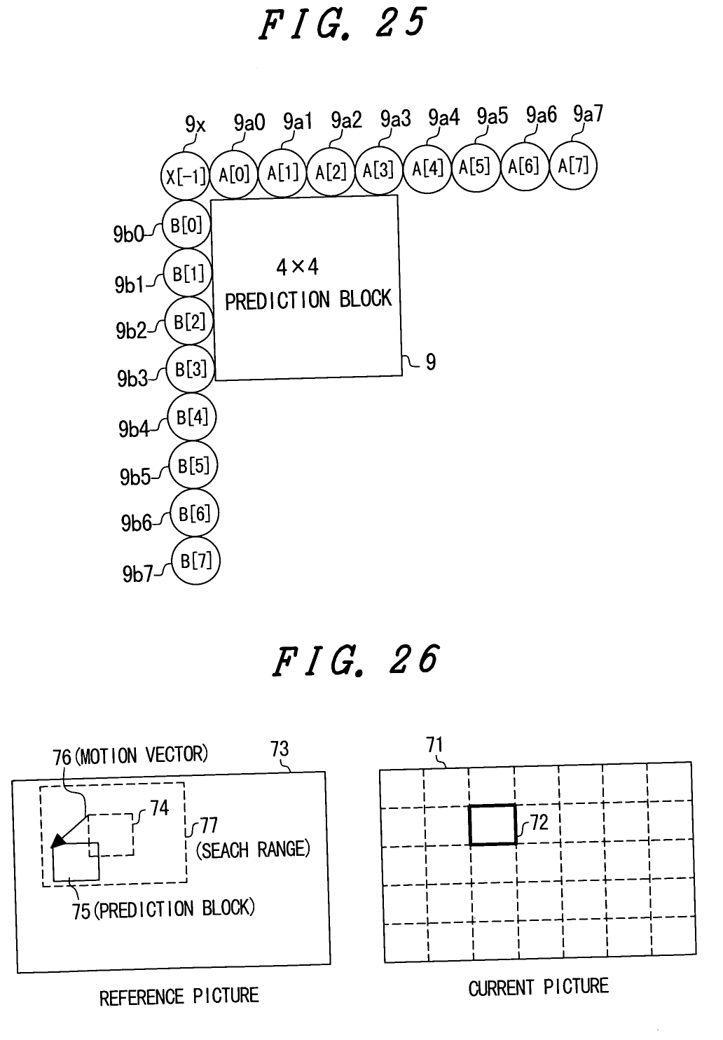

FIG. 20 shows such a motion picture coding apparatus configured by a plurality of portable telephones in the fourth embodiment of the present invention. In FIG. 20, each of terminals 901 to 904 is provided with an input unit 910 (910-1 to 910-4) for accepting inputs of the user.

For example, the motion picture coding apparatus is configured so that the terminal (portable telephone) 901 takes movie using an attached camera as a system management unit and allocates terminals 902 to 904 as mode selection units. Each terminal can thus decode a reconstructed image, since it can receive coded data therefrom in a process regardless of its shared workload. In such a case, the computing use of each terminal for distributed-coding process might affect such an ordinary use of telephone. To avoid such a trouble, the terminal is provided with the following functions to decide each operation of the terminal upon starting/ending a processing, as well as upon receiving a call so as to perform the distributed coding method of the present invention.

At first, the system management terminal 901 requests each of a plurality of portable telephones (terminals) for allocation (use). This request may be issued as any of phone call, e-mail, infrared ray communication, generation of sync signals with cable connection. Each of the portable telephones (terminals) 902 to 904, when receiving the request, displays the request information on the screen to prompt the user to input whether or not the request is accepted (use of the resource) through the input unit 910. To input a choice of the resource use, the user can decide the use condition (mode) from those prepared beforehand as follows according to the choice of the user.

1) Mode for turning off (disconnecting the portable radio line) only for sending/receiving of radio waves for confirming the current position to enable only local processings

2) Mode for notifying the system management terminal of rejection of the resource use when the phone is taken up for receiving a call

3) Mode for keeping the telephone conversation while the resource is on use

4) Mode for prompting the user to select a choice when receiving a call

At an end of coding, the system management terminal notifies each resource-used portable telephone of the end of the processing. Each terminal (portable telephone), when receiving the end notice, returns to the normal mode and displays the processing end message on the screen. At that time, the system management terminal also notifies each terminal of the information related to the coded data.

Because the motion picture coding apparatus is configured as described above, high quality images can be recorded at a plurality of portable telephones simultaneously.

In the fourth embodiment configured as described above, a portable telephone is divided into a plurality of resources for computing (a processing of one portable telephone is divided by a multi-core processor or shared by a plurality of portable telephones). Each portable telephone is specified as any of a system management unit, mode selection units, and a coding unit. Consequently, just like in the first to third embodiments, input images can be coded efficiently.

In the embodiments of the present invention described above, the coding method is not limited only to the AVC; various other methods may apply for prediction mode selection and prediction error information coding.

While lossless coding is employed for input images or input macroblocks in the first and second embodiments, non-lossless coding may also apply for them. Especially, when a system of which coding rate is low or system of which computing is slow is configured as described above, such a non-lossless coding method will ease the bus jamming more effectively.

According to the present invention, it is possible to create high quality compressed image data within a reasonable time even with use of a coding method that has many candidate prediction types.

Furthermore, according to the present invention, it is possible to employ an efficient parallel distributed processing method for prediction mode selection that has taken much computing time in accordance with the changes of image feature. For example, a search range of local motion estimation can be changed in a shared manner among a plurality of resources for computing in consideration of the difference of computing workload among macroblocks.

In addition, it is also possible for a plurality of resources for computing to share both reference frame and reference information (motion vector, etc.) used for prediction without jamming the bus, etc. Consequently, the image processing region of each resource for computing can be changed for each frame.

What is claimed is:

1. A motion picture coding apparatus connected to a plurality of resources for computing and used together with said plurality of resources for computing so as to encode input images, said apparatus comprising:
a region dividing unit for dividing an input image into a plurality of regions;
a control unit for allocating a prediction mode selection processing of each of said divided regions to said plurality of resources for computing;
a region data output unit for outputting said divided regions to said plurality of resources for computing upon said allocation;
a prediction type receiving unit for receiving prediction mode information selected by said plurality of resources for computing; and
an image data receiving unit for receiving coded data of said image in said selected prediction types.

2. The apparatus according to claim 1,
wherein said apparatus further includes a coding unit for coding said input image in said selected prediction types; and
wherein said image data receiving unit receives coded data coded by said coding unit.

3. The apparatus according to claim 1,
wherein said region dividing unit divides said input image into macroblocks.

4. The apparatus according to claim 2,
wherein said region dividing unit divides said input image into macroblocks.

5. The apparatus according to claim 1,
wherein said region data output unit outputs coded data of each of said divided regions to another resource for computing provided with a mode selection unit for selecting prediction types.

6. The apparatus according to claim 2,
wherein said region data output unit outputs coded data of each of said divided regions to another resource for computing provided with a mode selection unit for selecting prediction types.

7. The apparatus according to claim 1,
wherein said apparatus further includes a coded data output unit for outputting said coded data to another resource for computing provided with a mode selection unit for selecting prediction types in a bit stream format.

8. The apparatus according to claim 2,
wherein said apparatus further includes a coded data output unit for outputting said coded data to another resource for computing provided with a mode selection unit for selecting prediction types in a bit stream format.

9. The apparatus according to claim 1,
wherein said region data output unit outputs coded data of each of said divided regions with use of a lossless coding method.

10. The apparatus according to claim 2,
wherein said region data output unit outputs coded data of each of said divided regions with use of a lossless coding method.

11. A motion picture coding apparatus connected to a plurality of resources for computing and used together with said plurality of resources for computing so as to encode an input image, said apparatus comprising:
a region data receiving unit for receiving region data obtained by dividing an input image;
a mode selection unit for selecting a prediction type for each macroblock in said divided region;
a selected prediction mode data output unit for outputting selected prediction mode information;
a coded data receiving unit for receiving coded data of said input image;
a data decoding unit for decoding said received coded data; and
a storage unit for storing said reconstructed image of coded data.

12. An encoding program for computing data so as to encode an input image with use of a plurality of resources for computing among which a system management unit is included, said program comprising:
a step of receiving a prediction parameter for each region obtained by dividing an input image to be coded from said system management unit;
a step of receiving region data allocated to each resource for computing from said system management unit;
a step of selecting a prediction type for each macroblock in each of said divided region with use of said received prediction parameter
a step of transmitting said selected prediction types to said system management unit; and
a step of receiving coded data of said input image from said system management unit.

13. The program according to claim 8;
wherein said program further includes:
a step of receiving coded data of said input image to decode and store it as a reference image; and
a step of selecting prediction types with use of said reference image.

14. An encoding program for instructing a plurality of resources for computing to execute computing so as to encode an input image, said program comprising:
a step of allocating a resource for computing for system management and a plurality of resources for computing for mode selection;
a step of instructing said plurality of mode selection resources to receive macroblocks to be coded respectively;
a step of instructing said plurality of mode selection resources to execute a first mode selection for a stored reference image respectively;
a step of outputting results of said first mode selection to said system management resource;
a step of instructing said system management resource to execute a second mode selection including a reference image selection;
a step of outputting results of said second mode selection to said plurality of mode selection resources respectively; and
a step of instructing at least some of said plurality of mode selection resources to receive coded data.

15. The program according to claim 10,
wherein each of said plurality of resources for computing is configured by one of a plurality of processors provided with a memory respectively; and
wherein said system management resource is allocated to any one of said plurality of processors.
